(19) United States
(12) Patent Application Publication
(10) Pub. No.: US 2019/0068591 A1
(43) Pub. Date: Feb. 28, 2019

(54) Key Distribution And Authentication Method And System, And Apparatus

(71) Applicant: HUAWEI TECHNOLOGIES CO., LTD., Shenzhen (CN)

(72) Inventors: Bo ZHANG, Shenzhen (CN); Rong WU, Shenzhen (CN); Lu GAN, Shenzhen (CN); Haiguang WANG, Singapore (SG)

(21) Appl. No.: 16/171,235

(22) Filed: Oct. 25, 2018

Related U.S. Application Data
(63) Continuation of application No. PCT/CN2016/103334, filed on Oct. 26, 2016.

(30) Foreign Application Priority Data
Apr. 27, 2016 (CN) 201610268327.6

(51) Int. Cl. H04L 29/06; H04L 9/08; H04L 9/32

(52) U.S. Cl. CPC H04L 63/0869; H04L 9/0825; H04L 9/0838; H04L 63/064; H04L 9/3242; H04L 63/0876; H04L 9/0869

(57) ABSTRACT

The present disclosure relates to example key distribution and authentication methods and devices. In one example method, a second-level key is received by a terminal device from a user management server. The terminal device performs mutual authentication with a network authentication server based on the second-level key, to obtain a communication key for communication between the terminal device and a functional network element.

### CROSS-REFERENCE TO RELATED APPLICATIONS

This application is a continuation of International Application No. PCT/CN2016/103334, filed on Oct. 26, 2016, which claims priority to a Chinese Application No. 201610268327.6, filed on Apr. 27, 2016. The disclosures of the aforementioned applications are hereby incorporated by reference in their entireties.

### TECHNICAL FIELD

The present invention relates to the communications field, and in particular, to a key distribution and authentication method and system, and an apparatus.

### BACKGROUND

With development of communications network technologies, more devices, such as mobile phones, computers, unmanned aerial vehicles, and other Internet of things devices, start to join networks and send and receive data by using communications networks. There are also more companies, such as power companies, water companies, or heat companies, that implement communication between various intelligent devices implementing enterprise services and management centers of the companies by using communications networks.

To ensure secure communication, an intelligent device and a network usually perform mutual authentication based on a root key to establish a secure channel. The root key used in the mutual authentication process is configured in advance by a network operator or deployed in the intelligent device and the network. The existing authentication methods are all based on the Authentication and Key Agreement (AKA) protocol proposed by the International Mobile Telecommunications Organization, but the AKA protocol-based authentication method relies on the root key stored in a universal subscriber identity module (USIM) card, that is, requires the intelligent device to support the USIM card.

However, a large quantity of low-cost Internet of things devices or enterprise intelligent devices that access the network have simple functions and structures, and cannot be provided with functionally complex USIM cards, thereby failing to implement AKA protocol-based authentication and failing to apply existing authentication methods to establish secure communication channels. Therefore, existing root key deployment methods and authentication methods cannot be applied to secure communication between networks and an increasing quantity of intelligent devices that do not support USIM cards. As a result, security of communication between these intelligent devices and networks cannot be ensured.

### SUMMARY

Embodiments of the present invention provide a key distribution and authentication method and system, and an apparatus, so as to resolve a problem that existing root key deployment and authentication methods cannot be applied to an intelligent device that does not support a USIM card.

According to a first aspect, an embodiment of the present invention provides a key distribution method, including:

sending, by a user management server, a first key request message to a service center server, where the first key request message is used to instruct the service center server to generate a first-level key of the user management server, and the first key request message includes a user identifier of the user management server; receiving the first-level key of the user management server that is sent by the service center server; and generating a second-level key of a terminal device based on the first-level key, and sending the second-level key to the terminal device, so that the terminal device performs mutual authentication with a network authentication server based on the second-level key, to obtain a communication key for communication between the terminal device and a functional network element.

The user management server generates and distributes different second-level keys for different terminal device based on the received first-level key, so that the problem that existing root key deployment and authentication methods cannot be applied to an intelligent device that does not support a USIM card can be resolved, and load of the service center server for directly generating different second-level keys for different terminal devices is reduced.

With reference to the first aspect, in a first possible implementation of the first aspect, the process of generating a second-level key specifically includes: generating, by the user management server, the second-level key of the terminal device based on the first-level key and a first parameter set by using a key derivation function; and

the method further includes: sending, by the user management server, the first parameter set to the terminal device, where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key.

With reference to the first aspect, in a second possible implementation of the first aspect, the first-level key is a private key of the user management server, and the process of generating a second-level key specifically includes:

generating, by the user management server, the second-level key of the terminal device and a public key of the terminal device based on the private key of the user management server and a first parameter set, where the second-level key is a private key of the terminal device that is corresponding to the public key of the terminal device; and

the method further includes:

generating, by the user management server, a first digital signature based on the first-level key, the public key of the terminal device, and the first parameter set; and sending the public key of the terminal device, the first digital signature, and a second parameter set to the terminal device; where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the first aspect, in a third possible implementation of the first aspect, the first-level key is a private key of the user management server, and the process of generating a second-level key specifically includes:

generating, by the user management server, the second-level key of the terminal device based on the private key of the user management server and a device identifier of the terminal device by using a device identity-based generation algorithm, where the second-level key is a private key of the terminal device; and

the method further includes:

sending, by the user management server to the terminal device, a second parameter set and a public key of the terminal device that is corresponding to the private key of the terminal device, where

the second parameter set includes at least one of the user identifier of the user management server, the device identifier of the terminal device, a network identifier of the user management server, and a service parameter.

With reference to the first aspect, in a fourth possible implementation of the first aspect, the first-level key is a private key of the user management server, and the process of generating a second-level key specifically includes:

generating, by the user management server, the second-level key of the terminal device based on the private key of the user management server by using a privacy-enhancing technologies-based key generation algorithm, where the second-level key is a private key of the terminal device; and

the method further includes:

receiving, by the user management server, a public key of the user management server that is sent by the service center server, and sending the public key of the user management server and a second parameter set to the terminal device, where

the second parameter set includes at least one of the user identifier of the user management server, a device identifier of the terminal device, a network identifier of the user management server, and a service parameter.

According to a second aspect, an embodiment of the present invention provides a key distribution method, including:

receiving, by a service center server, a first key request message sent by a user management server, where the first key request message is used to instruct the service center server to generate a first-level key of the user management server, and the first key request message includes a user identifier of the user management server; and generating, based on the first key request message, the first-level key of the user management server corresponding to the user identifier, and sending the first-level key to the user management server.

The service center server generates first-level keys for different user management servers, so that the problem that existing root key deployment and authentication methods cannot be applied to an intelligent device that does not support a USIM card can be resolved.

With reference to the second aspect, in a first possible implementation of the second aspect, the process of generating the first-level key specifically includes: generating, by the service center server, the first-level key of the user management server based on a third parameter set by using a key derivation function, where

the third parameter set includes at least one of a key random number of the first-level key, a fresh parameter of the first-level key, a time parameter of the first-level key, and a shared key, and the shared key is a key shared by the user management server and the service center server; or

determining, by the service center server, a service random number and using the service random number as the first-level key of the user management server.

With reference to the second aspect, in a second possible implementation of the second aspect, the first key request message further includes at least one of a network identifier of the user management server and a service parameter, and the process of generating the first-level key specifically includes: generating, by the service center server, the first-level key of the user management server based on a fourth parameter set by using a key derivation function, where

the fourth parameter set includes at least one of the user identifier of the user management server, the network identifier of the user management server, the service parameter, a key random number of the first-level key, a fresh parameter of the first-level key, a time parameter of the first-level key, and a shared key, and the shared key is a key shared by the user management server and the service center server.

With reference to the second aspect, in a third possible implementation of the second aspect, the process of generating the first-level key specifically includes: generating, by the service center server, the first-level key of the user management server based on the user identifier of the user management server by using a key generation algorithm in identity-based cryptography, where the first-level key is a private key of the user management server.

With reference to the second aspect, in a fourth possible implementation of the second aspect, the process of generating the first-level key specifically includes: generating, by the service center server, the first-level key of the user management server based on the user identifier of the user management server and a fifth parameter set by using a key generation algorithm in identity-based cryptography, where the first-level key is a private key of the user management server, and

the fifth parameter set includes at least one of the following:

a key random number of the first-level key, a fresh parameter of the first-level key, and a time parameter of the first-level key.

With reference to the second aspect, in a fifth possible implementation of the second aspect, the process of generating the first-level key specifically includes: generating, by the service center server, a private key of the user management server and a public key of the user management server by using privacy-enhancing technologies, where the private key of the user management server is the first-level key of the user management server; and

the method further includes:

sending, by the service center server, the public key of the user management server to the user management server.

With reference to any one of the second aspect, the first possible implementation of the second aspect, and the second possible implementation of the second aspect, in a sixth possible implementation of the second aspect, the method further includes: receiving, by the service center server, a second key request message sent by a network authentication server, where the second key request message includes the user identifier of the user management server; and retrieving or generating the first-level key based on the user identifier of the user management server in the second key request message, and sending the first-level key to the network authentication server, so that the network authentication server generates a second-level key of a terminal device based on the first-level key, and performs mutual authentication with the terminal device based on the second-level key.

With reference to any one of the second aspect, the first possible implementation of the second aspect, and the second possible implementation of the second aspect, in a seventh possible implementation of the second aspect, the method further includes: receiving, by the service center server, a second key request message sent by a network authentication server, where the second key request message includes a first parameter set; and generating a second-level key of a terminal device based on the first-level key and the first parameter set by using the key derivation function, and sending the second-level key to the network authentication server, so that the network authentication server performs mutual authentication with the terminal device based on the second-level key; where

the first parameter set includes at least one of the user identifier of the user management server, a device identifier of the terminal device, the network identifier of the user management server, the service parameter, a key random number of the second-level key, a fresh parameter of the second-level key, and a time parameter of the second-level key.

According to a third aspect, an embodiment of the present invention provides a key authentication method, including:

receiving, by a terminal device, a second-level key of the terminal device that is sent by a user management server; and performing mutual authentication with a network authentication server based on the second-level key, to obtain a communication key for communication between the terminal device and a functional network element.

With reference to the third aspect, in a first possible implementation of the third aspect, the terminal device further receives a first parameter set sent by the user management server, and the mutual authentication process specifically includes:

determining, by the terminal device, a first random number, encrypting the first random number by using the second-level key, to obtain an encrypted first random number, and sending an authentication request message to the network authentication server, where the authentication request message includes the first parameter set and the encrypted first random number;

receiving, by the terminal device, an encrypted second random number and a second message authentication code that are sent by the network authentication server, and decrypting the encrypted second random number based on the second-level key to obtain a second random number, where the encrypted second random number is obtained after the network authentication server encrypts the second random number by using the second-level key; and

after the terminal device has authenticated the second message authentication code, generating, by the terminal device, the communication key of the terminal device based on a second parameter set and at least one of the second-level key, the first random number, and the second random number by using a key derivation function; generating a first message authentication code based on the first random number, the second random number, the second parameter set, and either of the communication key and the second-level key; and sending the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a second possible implementation of the third aspect, the terminal device further receives a first parameter set sent by the user management server, and the mutual authentication process specifically includes:

determining, by the terminal device, a first random number, and sending an authentication request message to the network authentication server, where the authentication request message includes the first parameter set and the first random number;

receiving, by the terminal device, a second random number and a second message authentication code that are sent by the network authentication server; and

after the terminal device has authenticated the second message authentication code, generating, by the terminal device, the communication key of the terminal device based on the second-level key and at least one of the first random number, the second random number, and a second parameter set by using a key derivation function; generating a first message authentication code based on the first random number, the second random number, the second parameter set, and either of the communication key and the second-level key; and sending the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a third possible implementation of the third aspect, the terminal device further receives a first parameter set sent by the user management server, and the mutual authentication process specifically includes:

determining, by the terminal device, a first random number, and sending an authentication request message to the network authentication server, where the authentication request message includes the first parameter set and the first random number;

receiving, by the terminal device, a second random number, a second message authentication code, and an encrypted communication key that are sent by the network authentication server, and decrypting the encrypted communication key based on the second-level key to obtain the communication key, where the encrypted communication key is obtained after the network authentication server encrypts the communication key by using the second-level key; and

after the terminal device has authenticated the second message authentication code, generating, by the terminal device, a first message authentication code based on the first random number, the second random number, a second parameter set, and either of the communication key and the second-level key; and sending the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a fourth possible implementation of the third aspect, the terminal device further receives a first parameter set sent by the user management server, and the mutual authentication process specifically includes:

determining, by the terminal device, a first random number and a first transmission parameter of a DH protocol, and sending an authentication request message to the network authentication server, where the authentication request message includes the first random number, the first transmission parameter, and the first parameter set;

receiving, by the terminal device, a second transmission parameter, a second random number, and a second message authentication code that are sent by the network authentication server, and performing a DH key agreement algorithm based on the first transmission parameter and the second transmission parameter to obtain a third transmission parameter; and

after the terminal device has authenticated the second message authentication code, generating, by the terminal device, the communication key of the terminal device based on the third transmission parameter and at least one of the first random number, the second random number, and a second parameter set by using a key derivation function; generating a first message authentication code based on the first random number, the second random number, the second parameter set, and either of the communication key and the second-level key by using a message authentication code generation function; and sending the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a fifth possible implementation of the third aspect, the terminal device further receives a first parameter set sent by the user management server, and the mutual authentication process specifically includes:

determining, by the terminal device, a first random number; encrypting the first random number by using the second-level key, to obtain an encrypted first random number; generating a first message authentication code based on the second-level key and at least one of a second parameter set and the first random number by using a message authentication code generation function; and sending an authentication request message to the network authentication server, where the authentication request message includes the first message authentication code, the encrypted first random number, and the first parameter set;

receiving, by the terminal device, a second message authentication code and an encrypted second random number that are sent by the network authentication server, and decrypting the encrypted second random number based on the second-level key to obtain a second random number, where the encrypted second random number is obtained after the network authentication server encrypts the second random number by using the second-level key; and

after the terminal device has authenticated the second message authentication code, generating, by the terminal device, the communication key of the terminal device based on the second parameter set and at least one of the second-level key, the first random number, and the second random number by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a sixth possible implementation of the third aspect, the terminal device further receives a first parameter set sent by the user management server, and the mutual authentication process specifically includes:

determining, by the terminal device, a first random number; generating a first message authentication code based on the second-level key and at least one of a second parameter set and the first random number by using a message authentication code generation function; and sending an authentication request message to the network authentication server, where the authentication request message includes the first message authentication code, the first random number, and the first parameter set;

receiving, by the terminal device, a second random number and a second message authentication code that are sent by the network authentication server; and

after the terminal device has authenticated the second message authentication code, generating, by the terminal device, the communication key of the terminal device based on the second-level key and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a seventh possible implementation of the third aspect, the terminal device further receives a first parameter set sent by the user management server, and the mutual authentication process specifically includes:

determining, by the terminal device, a first random number; generating a first message authentication code based on the second-level key and at least one of a second parameter set and the first random number by using a message authentication code generation function; and sending an authentication request message to the network authentication server, where the authentication request message includes the first message authentication code, the first random number, and the first parameter set;

receiving, by the terminal device, a second random number, a second message authentication code, and an encrypted communication key that are sent by the network authentication server; and

after the terminal device has authenticated the second message authentication code based on the second random number, decrypting, by the terminal device, the encrypted communication key based on the second-level key to obtain the communication key; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in an eighth possible implementation of the third aspect, the terminal device further receives a first parameter set sent by the user management server, and the mutual authentication process specifically includes:

determining, by the terminal device, a first random number; encrypting the first random number by using the second-level key, to obtain an encrypted first random number; generating the communication key of the terminal device based on a second parameter set and at least one of the second-level key and the first random number by using a key derivation function; generating a first message authentication code based on either of the second-level key and the communication key and at least one of the second parameter set and the first random number by using a message authentication code generation function; and sending an authentication request message to the network authentication server, where the authentication request message includes the first message authentication code, the encrypted first random number, and the first parameter set; and

receiving, by the terminal device, a second message authentication code and an encrypted second random number that are sent by the network authentication server; decrypting the encrypted second random number based on the second-level key to obtain a second random number, where the encrypted second random number is obtained after the network authentication server encrypts the second random number by using the second-level key; and attempting to authenticate the second message authentication code based on the second random number and determining that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a ninth possible implementation of the third aspect, the terminal device further receives a first parameter set sent by the user management server, and the mutual authentication process specifically includes:

determining, by the terminal device, a first random number; generating the communication key of the terminal device based on the second-level key and at least one of the first random number and a second parameter set by using a key derivation function; generating a first message authentication code based on either of the second-level key and the communication key and at least one of the second parameter set and the first random number by using a message authentication code generation function; and sending an authentication request message to the network authentication server, where the authentication request message includes the first message authentication code, the first random number, and the first parameter set; and

receiving, by the terminal device, a second random number and a second message authentication code that are sent by the network authentication server, and attempting to authenticate the second message authentication code and determining that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in a tenth possible implementation of the third aspect, the terminal device further receives a first parameter set sent by the user management server, and the mutual authentication process specifically includes:

determining, by the terminal device, a first random number and a first transmission parameter of a DH protocol; generating a first message authentication code based on the second-level key, the first random number, and a second parameter set by using a message authentication code generation function; and sending an authentication request message to the network authentication server, where the authentication request message includes the first random number, the first transmission parameter, the first message authentication code, and the first parameter set;

receiving, by the terminal device, a second transmission parameter, a second random number, and a second message authentication code that are sent by the network authentication server, and performing a DH key agreement algorithm based on the first transmission parameter and the second transmission parameter to obtain a third transmission parameter; and

after the terminal device has authenticated the second message authentication code, generating, by the terminal device, the communication key of the terminal device based on the third transmission parameter and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the third aspect, in an eleventh possible implementation of the third aspect, the terminal device further receives a public key of the terminal device, a first digital signature, and a second parameter set that are sent by the user management server, and the mutual authentication process specifically includes:

determining, by the terminal device, a first random number, encrypting the first random number by using a public key of the network authentication server, to obtain an encrypted first random number, and sending an authentication request message to the network authentication server, where the authentication request message includes the public key of the terminal device, the first digital signature, the encrypted first random number, and the second parameter set;

receiving, by the terminal device, an encrypted second random number and a second digital signature that are sent by the network authentication server, and decrypting the encrypted second random number based on the second-level key of the terminal device to obtain a second random number, where the encrypted second random number is obtained after the network authentication server encrypts the second random number by using the public key of the terminal device; and

after the terminal device has authenticated the second digital signature, generating, by the terminal device, the communication key of the terminal device based on the second parameter set and at least one of the first random number and the second random number by using a key derivation function; generating a first message authentication code based on the communication key, the first random number, the second random number, and the second parameter set, or generating a third digital signature based on the second-level key, the first random number, the second random number, and the second parameter set; and sending the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to the third aspect, in a twelfth possible implementation of the third aspect, the terminal device further receives a public key of the terminal device and a second parameter set that are sent by the user management server, and the mutual authentication process specifically includes:

determining, by the terminal device, a first random number, encrypting the first random number by using a public key of the network authentication server, to obtain an encrypted first random number, and sending an authentication request message to the network authentication server, where the authentication request message includes the public key of the terminal device, the encrypted first random number, and the second parameter set;

receiving, by the terminal device, an encrypted second random number and a second digital signature that are sent by the network authentication server, and decrypting the encrypted second random number based on the second-level key of the terminal device to obtain a second random number, where the encrypted second random number is obtained after the network authentication server encrypts the second random number by using the public key of the terminal device; and

after the terminal device has authenticated the second digital signature, generating, by the terminal device, the communication key of the terminal device based on the second parameter set and at least one of the first random number and the second random number by using a key derivation function; generating a first message authentication code based on the communication key, the first random number, the second random number, and the second parameter set, or generating a third digital signature based on the second-level key, the first random number, the second random number, and the second parameter set; and sending the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to the third aspect, in a thirteenth possible implementation of the third aspect, the terminal device further receives a public key of the user management server and a second parameter set that are sent by the user management server, where the public key of the user management server is a public key of the terminal device that is corresponding to the second-level key of the terminal device; and the mutual authentication process specifically includes:

determining, by the terminal device, a first random number and a first transmission parameter of a DH protocol, and sending an authentication request message to the network authentication server, where the authentication request message includes the public key of the terminal device, the first random number, the first transmission parameter, and the second parameter set;

receiving, by the terminal device, a second transmission parameter, a second random number, and a second digital signature that are sent by the network authentication server, and performing a DH key agreement algorithm based on the first transmission parameter and the second transmission parameter to obtain a third transmission parameter; and

after the terminal device has authenticated the second digital signature, generating, by the terminal device, the communication key of the terminal device based on the third transmission parameter and at least one of the first random number, the second random number, and the second parameter set by using a key derivation function; generating a first message authentication code based on the communication key, the first transmission parameter, the second transmission parameter, and at least one of the first random number, the second random number, and the second parameter set by using a message authentication code generation function, or generating a third digital signature based on the second-level key, the first transmission parameter, the second transmission parameter, and at least one of the first random number, the second random number, and the second parameter set; and sending the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to any one of the eleventh to the thirteenth possible implementations of the third aspect, in a fourteenth possible implementation of the third aspect, the terminal device further sends a public key request message to the network authentication server; and receiving the public key of the network authentication server that is sent by the network authentication server.

With reference to any one of the third aspect, and the first to the fourteenth possible implementations of the third aspect, in a fifteenth possible implementation of the third aspect, the method further includes: performing mutual authentication with the network authentication server, and generating a session key of the terminal device based on any one of the communication key, the second parameter set, a random number of the session key, a fresh parameter of the session key, and a preset time parameter of the session key by using the key derivation function.

The following fourth and fifth aspects provide a key authentication method to interact with the key authentication method provided in the foregoing third aspect, and the key authentication method is a symmetric side method and has a corresponding technical feature and technical effect. Details are not described in this embodiment of the present invention.

According to the fourth aspect, an embodiment of the present invention provides a key authentication method, including:

receiving, by a network authentication server, an authentication request message sent by a terminal device, where the authentication request message includes a first parameter set, sending a second key request message to a service center server, and receiving a second-level key sent by the service center server, where the second key request message includes the first parameter set; or receiving, by a network authentication server, an authentication request message sent by a terminal device, where the authentication request message includes a first parameter set, sending a second key request message to a service center server, receiving a first-level key sent by the service center server, and generating, by the network authentication server, a second-level key of the terminal device based on the first-level key and the first parameter set by using a key derivation function; and

performing, by the network authentication server, mutual authentication with the terminal device based on the second-level key, to obtain a communication key for communication between the terminal device and a functional network element; where

the first parameter set includes at least one of a user identifier of a user management server, a device identifier of the terminal device, a network identifier of the user management server, a service parameter, a key random number of the second-level key, a fresh parameter of the second-level key, and a time parameter of the second-level key.

With reference to the fourth aspect, in a first possible implementation of the fourth aspect, the authentication request message further includes an encrypted first random number, and the mutual authentication process specifically includes:

decrypting, by the network authentication server, the encrypted first random number based on the second-level key to obtain a first random number, determining a second random number, and encrypting the second random number by using the second-level key, to obtain an encrypted second random number, where the encrypted first random number is obtained after the terminal device encrypts the first random number by using the second-level key;

generating, by the network authentication server, the communication key of the network authentication server based on a second parameter set and at least one of the second-level key, the first random number, and the second random number by using the key derivation function; generating a second message authentication code based on the first random number, the second random number, the second parameter set, and either of the communication key and the second-level key; and sending the encrypted second random number and the second message authentication code to the terminal device; and

receiving, by the network authentication server, a first message authentication code sent by the terminal device, and sending the communication key to the functional network element after the network authentication server has authenticated the first message authentication code; where

the second parameter set includes at least one of the user identifier of the user management server, the device identifier of the terminal device, the network identifier of the user management server, and the service parameter.

With reference to the fourth aspect, in a second possible implementation of the fourth aspect, the authentication request message further includes a first random number, and the mutual authentication process specifically includes:

determining, by the network authentication server, a second random number; generating the communication key of the network authentication server based on the second-level key and at least one of the first random number, the second random number, and a second parameter set by using the key derivation function; generating a second message authentication code based on the first random number, the second random number, the second parameter set, and either of the communication key and the second-level key; and sending the second random number and the second message authentication code to the terminal device; and

receiving, by the network authentication server, a first message authentication code sent by the terminal device, and sending the communication key to the functional network element after the network authentication server has authenticated the first message authentication code; where

the second parameter set includes at least one of the user identifier of the user management server, the device identifier of the terminal device, the network identifier of the user management server, and the service parameter.

With reference to the fourth aspect, in a third possible implementation of the fourth aspect, the authentication request message further includes a first random number, and the mutual authentication process specifically includes:

determining, by the network authentication server, a second random number; generating the communication key of the network authentication server based on a key random number; encrypting the communication key by using the second-level key, to obtain an encrypted communication key; generating a second message authentication code based on the first random number, the second random number, a second parameter set, and either of the communication key and the second-level key; and sending the second random number, the encrypted communication key, and the second message authentication code to the terminal device; and

receiving, by the network authentication server, a first message authentication code sent by the terminal device, and sending the communication key to the functional network element after the network authentication server has authenticated the first message authentication code; where

the second parameter set includes at least one of the user identifier of the user management server, the device identifier of the terminal device, the network identifier of the user management server, and the service parameter.

With reference to the fourth aspect, in a fourth possible implementation of the fourth aspect, the authentication request message further includes a first transmission parameter and a first random number, and the mutual authentication process specifically includes:

determining, by the network authentication server, a second random number and a second transmission parameter of a DH protocol, and performing a DH key agreement algorithm based on the first transmission parameter and the second transmission parameter to obtain a third transmission parameter; and

generating, by the network authentication server, the communication key of the network authentication server based on the third transmission parameter and at least one of the first random number, the second random number, and a second parameter set by using the key derivation function; generating a second message authentication code based on the first transmission parameter, the second transmission parameter, the second parameter set, and either of the communication key and the second-level key; and sending the second random number and the second message authentication code to the terminal device; and

receiving, by the network authentication server, a first message authentication code sent by the terminal device, and sending the communication key to the functional network element after the network authentication server has authenticated the first message authentication code; where

the second parameter set includes at least one of the user identifier of the user management server, the device identifier of the terminal device, the network identifier of the user management server, and the service parameter.

With reference to the fourth aspect, in a fifth possible implementation of the fourth aspect, the authentication request message further includes a first message authentication code and an encrypted first random number, and the mutual authentication process specifically includes:

decrypting, by the network authentication server, the encrypted first random number based on the second-level key to obtain a first random number, determining a second random number, and encrypting the second random number by using the second-level key, to obtain an encrypted second random number, where the encrypted first random number is obtained after the terminal device encrypts the first random number by using the second-level key; and

after the network authentication server has authenticated the first message authentication code, generating, by the network authentication server, the communication key of the network authentication server based on a second parameter set and at least one of the second-level key, the first random number, and the second random number by using the key derivation function; generating a second message authentication code based on either of the communication key and the second-level key and at least one of the first random number, the second random number, and the second parameter set; and sending the encrypted second random number and the second message authentication code to the terminal device, and sending the communication key to the functional network element; where

the second parameter set includes at least one of the user identifier of the user management server, the device identifier of the terminal device, the network identifier of the user management server, and the service parameter.

With reference to the fourth aspect, in a sixth possible implementation of the fourth aspect, the authentication request message further includes a first message authentication code and a first random number, and the mutual authentication process specifically includes:

determining, by the network authentication server, a second random number; after the network authentication server has authenticated the first message authentication code, generating the communication key of the network authentication server based on the second-level key and at least one of the first random number, the second random number, and a second parameter set by using the key derivation function; generating a second message authentication code based on either of the communication key and the second-level key and at least one of the first random number, the second random number, and the second parameter set; and sending the encrypted second random number and the second message authentication code to the terminal device, and sending the communication key to the functional network element; where

the second parameter set includes at least one of the user identifier of the user management server, the device identifier of the terminal device, the network identifier of the user management server, and the service parameter.

With reference to the fourth aspect, in a seventh possible implementation of the fourth aspect, the authentication request message further includes a first message authentication code and a first random number, and the mutual authentication process specifically includes:

determining, by the network authentication server, a second random number; after the network authentication server has authenticated the first message authentication code, generating the communication key of the network authentication server based on a key random number; encrypting the communication key by using the second-level key, to obtain an encrypted communication key; generating a second message authentication code based on either of the communication key and the second-level key and at least one of the first random number, the second random number, and a second parameter set; and sending the second random number, the encrypted communication key, and the second message authentication code to the terminal device, and sending the communication key to the functional network element; where

the second parameter set includes at least one of the user identifier of the user management server, the device identifier of the terminal device, the network identifier of the user management server, and the service parameter.

With reference to the fourth aspect, in an eighth possible implementation of the fourth aspect, the authentication request message further includes a first message authentication code and an encrypted first random number, and the mutual authentication process specifically includes:

decrypting, by the network authentication server, the encrypted first random number based on the second-level key to obtain a first random number, determining a second random number, and encrypting the second random number by using the second-level key, to obtain an encrypted second random number, where the encrypted first random number is obtained after the terminal device encrypts the first random number by using the second-level key; and

after the network authentication server has authenticated the first message authentication code, generating, by the network authentication server, the communication key of the terminal device based on a second parameter set and at least one of the second-level key and the first random number by using the key derivation function; generating a second message authentication code based on either of the communication key and the second-level key and at least one of the first random number, the second random number, and the second parameter set; and sending the encrypted second random number and the second message authentication code to the terminal device, and sending the communication key to the functional network element; where

the second parameter set includes at least one of the user identifier of the user management server, the device identifier of the terminal device, the network identifier of the user management server, and the service parameter.

With reference to the fourth aspect, in a ninth possible implementation of the fourth aspect, the authentication request message further includes a first message authentication code and a first random number, and the mutual authentication process specifically includes:

determining, by the network authentication server, a second random number; after the network authentication server has authenticated the first message authentication code, generating the communication key of the terminal device based on the second-level key and at least one of the first random number and a second parameter set by using the key derivation function; generating a second message authentication code based on either of the communication key and the second-level key and at least one of the first random number, the second random number, and the second parameter set; and sending the second random number and the second message authentication code to the terminal device, and sending the communication key to the functional network element, where the second parameter set includes at least one of the user identifier of the user management server, the device identifier of the terminal device, the network identifier of the user management server, and the service parameter.

With reference to the fourth aspect, in a tenth possible implementation of the fourth aspect, the authentication request message further includes a first message authentication code, a first transmission parameter, and a first random number, and the mutual authentication process specifically includes:

determining, by the network authentication server, a second random number and a second transmission parameter of a DH protocol, and performing a DH key agreement algorithm based on the first transmission parameter and the second transmission parameter to obtain a third transmission parameter; and

after the network authentication server has authenticated the first message authentication code, generating, by the network authentication server, the communication key of the network authentication server based on the third transmission parameter and at least one of the first random number, the second random number, and a second parameter set by using the key derivation function; generating a second message authentication code based on either of the communication key and the second-level key and any one of the first random number, the second random number, the first transmission parameter, the second transmission parameter, and the second parameter set; and sending the second random number and the second message authentication code to the terminal device, and sending the communication key to the functional network element; where

the second parameter set includes at least one of the user identifier of the user management server, the device identifier of the terminal device, the network identifier of the user management server, and the service parameter.

With reference to any one of the fourth aspect, and the first to the tenth possible implementations of the fourth aspect, in an eleventh possible implementation of the fourth aspect, the method further includes: performing, by the network authentication server, mutual authentication with the terminal device, generating a session key of the network authentication server based on any one of the communication key, the second parameter set, a random number of the session key, a fresh parameter of the session key, and a preset time parameter of the session key by using the key derivation function, and sending the session key to the functional network element.

According to the fifth aspect, an embodiment of the present invention provides a key authentication method, including:

receiving, by a network authentication server, an authentication request message sent by a terminal device, where the authentication request message includes a public key of the terminal device; and performing mutual authentication with the terminal device based on the public key of the terminal device, a public key of the network authentication server, and a private key of the network authentication server, to obtain a communication key for communication between the terminal device and a functional network element.

With reference to the fifth aspect, in a first possible implementation of the fifth aspect, the authentication request message further includes a first digital signature, an encrypted first random number, and a second parameter set, and the mutual authentication process specifically includes:

decrypting, by the network authentication server, the encrypted first random number based on the private key of the network authentication server to obtain a first random number, determining a second random number, and encrypting the second random number by using the public key of the terminal device, to obtain an encrypted second random number, where the encrypted first random number is obtained after the terminal device encrypts the first random number by using the public key of the network authentication server;

after the network authentication server has authenticated the first digital signature, generating, by the network authentication server, the communication key of the network authentication server based on the second parameter set and at least one of the first random number and the second random number by using a key derivation function; generating a second digital signature based on the private key of the network authentication server, the first random number, the second random number, and the second parameter set; and sending the second digital signature and the encrypted second random number to the terminal device; and

receiving, by the network authentication server, a first message authentication code or a third digital signature sent by the terminal device, and sending the communication key to the functional network element after the network authentication server has authenticated the first message authentication code or the third digital signature; where

the second parameter set includes at least one of a user identifier of a user management server, a device identifier of the terminal device, a network identifier of the user management server, and a service parameter.

With reference to the fifth aspect, in a second possible implementation of the fifth aspect, the authentication request message further includes an encrypted first random number and a second parameter set, and the mutual authentication process specifically includes:

decrypting, by the network authentication server, the encrypted first random number based on the private key of the network authentication server to obtain a first random number, determining a second random number, and encrypting the second random number by using the public key of the terminal device, to obtain an encrypted second random number, where the encrypted first random number is obtained after the terminal device encrypts the first random number by using the public key of the network authentication server;

generating, by the network authentication server, the communication key of the network authentication server based on the second parameter set and at least one of the first random number and the second random number by using a key derivation function; generating a second digital signature based on the private key of the network authentication server, the first random number, the second random number, and the second parameter set; and sending the encrypted second random number and the second digital signature to the terminal device; and

receiving, by the network authentication server, a first message authentication code or a third digital signature sent by the terminal device, and sending the communication key to the functional network element after the network authentication server has authenticated the first message authentication code or the third digital signature; where

the second parameter set includes at least one of a user identifier of a user management server, a device identifier of the terminal device, a network identifier of the user management server, and a service parameter.

With reference to the fifth aspect, in a third possible implementation of the fifth aspect, the authentication request message further includes a first random number, a first transmission parameter, and a second parameter set, and the mutual authentication process specifically includes:

determining, by the network authentication server, a second random number and a second transmission parameter of a DH protocol, and performing a DH key agreement algorithm based on the first transmission parameter and the second transmission parameter to obtain a third transmission parameter; and

generating, by the network authentication server, the communication key of the network authentication server based on the third transmission parameter and at least one of the first random number, the second random number, and the second parameter set by using a key derivation function; generating a second digital signature based on the private key of the network authentication server, the first transmission parameter, the second transmission parameter, and at least one of the first random number, the second random number, and the second parameter set; and sending the second random number, the second transmission parameter, and the second digital signature to the terminal device; and

receiving, by the network authentication server, a first message authentication code or a third digital signature sent by the terminal device, and sending the communication key to the functional network element after the network authentication server has authenticated the first message authentication code or after the network authentication server has authenticated the third digital signature based on the public key of the terminal device; where

the second parameter set includes at least one of a user identifier of a user management server, a device identifier of the terminal device, a network identifier of the user management server, and a service parameter.

With reference to any one of the fifth aspect, and the first to the third possible implementations of the fifth aspect, in a fourth possible implementation of the fifth aspect, the network authentication server further receives a public key request message sent by the terminal device; and the network authentication server sends the public key of the network authentication server to the terminal device.

With reference to any one of the fifth aspect, and the first to the fourth possible implementations of the fifth aspect, in a fifth possible implementation of the fifth aspect, the method further includes: performing, by the network authentication server, mutual authentication with the terminal device, generating a session key of the network authentication server based on any one of the communication key, the second parameter set, a random number of the session key, a fresh parameter of the session key, and a preset time parameter of the session key by using the key derivation function, and sending the session key to the functional network element.

The following describes key distribution and authentication apparatuses provided in the embodiments of the present invention. The apparatuses are in a one-to-one correspondence with the foregoing methods, and are configured to implement the key distribution and authentication method in the foregoing embodiments. The key distribution and authentication apparatuses have the same technical features and technical effects as the key distribution and authentication method in the foregoing embodiments. Details are not described in this embodiment of the present invention.

According to a sixth aspect, an embodiment of the present invention provides a user management server, including:

a request sending module, configured to send a first key request message to a service center server, where the first key request message is used to instruct the service center server to generate a first-level key of the user management server, and the first key request message includes a user identifier of the user management server;

a key receiving module, configured to receive the first-level key of the user management server that is sent by the service center server; and

a key generation and distribution module, configured to: generate a second-level key of a terminal device based on the first-level key, and send the second-level key to the terminal device, so that the terminal device performs mutual authentication with a network authentication server based on the second-level key, to obtain a communication key for communication between the terminal device and a functional network element.

With reference to the sixth aspect, in a first possible implementation of the sixth aspect, the key generation and distribution module is specifically configured to:

generate the second-level key of the terminal device based on the first-level key and a first parameter set by using a key derivation function; and send the second-level key and the first parameter set to the terminal device, so that the terminal device performs mutual authentication with the network authentication server based on the second-level key, to obtain the communication key for communication between the terminal device and the functional network element; where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key.

With reference to the sixth aspect, in a second possible implementation of the sixth aspect, the first-level key is a private key of the user management server, and the key generation and distribution module is specifically configured to:

generate the second-level key of the terminal device and a public key of the terminal device based on the private key of the user management server and a first parameter set, where the second-level key is a private key of the terminal device that is corresponding to the public key of the terminal device;

generate a first digital signature based on the first-level key, the public key of the terminal device, and the first parameter set; and

send the public key of the terminal device, the second-level key, the first digital signature, and a second parameter set to the terminal device, so that the terminal device performs mutual authentication with the network authentication server based on the second-level key, to obtain the communication key for communication between the terminal device and the functional network element; where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the sixth aspect, in a third possible implementation of the sixth aspect, the first-level key is a private key of the user management server, and the key generation and distribution module is specifically configured to:

generate the second-level key of the terminal device based on the private key of the user management server and a device identifier of the terminal device by using a device identity-based generation algorithm, where the second-level key is a private key of the terminal device; and

send, to the terminal device, a second parameter set, the second-level key, and a public key of the terminal device that is corresponding to the private key of the terminal device, so that the terminal device performs mutual authentication with the network authentication server based on the second-level key, to obtain the communication key for communication between the terminal device and the functional network element; where

the second parameter set includes at least one of the user identifier of the user management server, the device identifier of the terminal device, a network identifier of the user management server, and a service parameter.

With reference to the sixth aspect, in a fourth possible implementation of the sixth aspect, the first-level key is a private key of the user management server, and the key receiving module is further configured to receive a public key of the user management server that is sent by the service center server; and the key generation and distribution module is specifically configured to:

generate the second-level key of the terminal device based on the private key of the user management server by using a privacy-enhancing technologies-based key generation algorithm, where the second-level key is a private key of the terminal device; and

send the public key of the user management server, the second-level key, and a second parameter set to the terminal device, so that the terminal device performs mutual authentication with the network authentication server based on the second-level key, to obtain the communication key for communication between the terminal device and the functional network element, where

the second parameter set includes at least one of the user identifier of the user management server, a device identifier of the terminal device, a network identifier of the user management server, and a service parameter.

According to a seventh aspect, an embodiment of the present invention provides a service center server, including:

a key request receiving module, configured to receive a first key request message sent by a user management server, where the first key request message is used to instruct the service center server to generate a first-level key of the user management server, and the first key request message includes a user identifier of the user management server; and

a key generation and distribution module, configured to: generate, based on the first key request message, the first-level key of the user management server corresponding to the user identifier, and send the first-level key to the user management server.

With reference to the seventh aspect, in a first possible implementation of the seventh aspect, the key generation and distribution module is specifically configured to:

generate the first-level key of the user management server based on a third parameter set by using a key derivation function, and send the first-level key to the user management server; where

the third parameter set includes at least one of a key random number of the first-level key, a fresh parameter of the first-level key, a time parameter of the first-level key, and a shared key, and the shared key is a key shared by the user management server and the service center server;

or

determine a service random number, use the service random number as the first-level key of the user management server, and send the first-level key to the user management server.

With reference to the seventh aspect, in a second possible implementation of the seventh aspect, the first key request message further includes at least one of a network identifier of the user management server and a service parameter, and the key generation and distribution module is specifically configured to: generate the first-level key of the user management server based on a fourth parameter set by using a key derivation function, and send the first-level key to the user management server; where

the fourth parameter set includes at least one of the user identifier of the user management server, the network identifier of the user management server, the service parameter, a key random number of the first-level key, a fresh parameter of the first-level key, a time parameter of the first-level key, and a shared key, and the shared key is a key shared by the user management server and the service center server.

With reference to the seventh aspect, in a third possible implementation of the seventh aspect, the key generation and distribution module is specifically configured to:

generate the first-level key of the user management server based on the user identifier of the user management server by using a key generation algorithm in identity-based cryptography, and send the first-level key to the user management server, where the first-level key is a private key of the user management server.

With reference to the seventh aspect, in a fourth possible implementation of the seventh aspect, the key generation and distribution module is specifically configured to: generate the first-level key of the user management server based on the user identifier of the user management server and a fifth parameter set by using a key generation algorithm in identity-based cryptography, and send the first-level key to the user management server, where the first-level key is a private key of the user management server, and

the fifth parameter set includes at least one of the following:

a key random number of the first-level key, a fresh parameter of the first-level key, and a time parameter of the first-level key.

With reference to the seventh aspect, in a fifth possible implementation of the seventh aspect, the key generation and distribution module is specifically configured to:

generate a private key of the user management server and a public key of the user management server by using privacy-enhancing technologies, where the private key of the user management server is the first-level key of the user management server; and send the first-level key and the public key of the user management server to the user management server.

With reference to any one of the seventh aspect, the first possible implementation of the seventh aspect, and the second possible implementation of the seventh aspect, in a sixth possible implementation of the seventh aspect, the key request receiving module is further configured to receive a second key request message sent by the network authentication server, where the second key request message includes the user identifier of the user management server; and

the key generation and distribution module is further configured to: retrieve or generate the first-level key based on the user identifier of the user management server in the second key request message, and send the first-level key to the network authentication server, so that the network authentication server generates a second-level key of a terminal device based on the first-level key, and performs mutual authentication with the terminal device based on the second-level key.

With reference to any one of the seventh aspect, the first possible implementation of the seventh aspect, and the second possible implementation of the seventh aspect, in a seventh possible implementation of the seventh aspect, the key request receiving module is further configured to receive a second key request message sent by the network authentication server, where the second key request message includes a first parameter set; and

the key generation and distribution module is further configured to: generate a second-level key of a terminal device based on the first-level key and the first parameter set by using the key derivation function, and send the second-level key to the network authentication server, so that the network authentication server performs mutual authentication with the terminal device based on the second-level key; where

the first parameter set includes at least one of the user identifier of the user management server, a device identifier of the terminal device, the network identifier of the user management server, the service parameter, a key random number of the second-level key, a fresh parameter of the second-level key, and a time parameter of the second-level key.

According to an eighth aspect, an embodiment of the present invention provides a terminal device, including:

a key receiving module, configured to receive a second-level key of the terminal device that is sent by a user management server; and

an authentication module, configured to perform mutual authentication with a network authentication server based on the second-level key, to obtain a communication key for communication between the terminal device and a functional network element.

With reference to the eighth aspect, in a first possible implementation of the eighth aspect, the key receiving module is further configured to receive a first parameter set sent by the user management server; and the authentication module is specifically configured to:

determine a first random number, encrypt the first random number by using the second-level key, to obtain an encrypted first random number, and send an authentication request message to the network authentication server, where the authentication request message includes the first parameter set and the encrypted first random number;

receive an encrypted second random number and a second message authentication code that are sent by the network authentication server, and decrypt the encrypted second random number based on the second-level key to obtain a second random number, where the encrypted second random number is obtained after the network authentication server encrypts the second random number by using the second-level key; and

after the second message authentication code has been authenticated, generate the communication key of the terminal device based on a second parameter set and at least one of the second-level key, the first random number, and the second random number by using a key derivation function; generate a first message authentication code based on the first random number, the second random number, the second parameter set, and either of the communication key and the second-level key; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a second possible implementation of the eighth aspect, the key receiving module is further configured to receive a first parameter set sent by the user management server; and the authentication module is specifically configured to:

determine a first random number, and send an authentication request message to the network authentication server, where the authentication request message includes the first parameter set and the first random number;

receive a second random number and a second message authentication code that are sent by the network authentication server; and

after the second message authentication code has been authenticated, generate the communication key of the terminal device based on the second-level key and at least one of the first random number, the second random number, and a second parameter set by using a key derivation function; generate a first message authentication code based on the first random number, the second random number, the second parameter set, and either of the communication key and the second-level key; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a third possible implementation of the eighth aspect, the key receiving module is further configured to receive a first parameter set sent by the user management server; and the authentication module is specifically configured to:

determine a first random number, and send an authentication request message to the network authentication server, where the authentication request message includes the first parameter set and the first random number;

receive a second random number, a second message authentication code, and an encrypted communication key that are sent by the network authentication server, and decrypt the encrypted communication key based on the second-level key to obtain the communication key, where the encrypted communication key is obtained after the network authentication server encrypts the communication key by using the second-level key; and

after the second message authentication code has been authenticated, generate a first message authentication code based on the first random number, the second random number, a second parameter set, and either of the communication key and the second-level key; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a fourth possible implementation of the eighth aspect, the key receiving module is further configured to receive a first parameter set sent by the user management server; and the authentication module is specifically configured to:

determine a first random number and a first transmission parameter of a DH protocol, and send an authentication request message to the network authentication server, where the authentication request message includes the first random number, the first transmission parameter, and the first parameter set;

receive a second transmission parameter, a second random number, and a second message authentication code that are sent by the network authentication server, and perform a DH key agreement algorithm based on the first transmission parameter and the second transmission parameter to obtain a third transmission parameter; and

after the second message authentication code has been authenticated, generate the communication key of the terminal device based on the third transmission parameter and at least one of the first random number, the second random number, and a second parameter set by using a key derivation function; generate a first message authentication code based on the first random number, the second random number, the second parameter set, and either of the communication key and the second-level key by using a message authentication code generation function; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a fifth possible implementation of the eighth aspect, the key receiving module is further configured to receive a first parameter set sent by the user management server; and the authentication module is specifically configured to:

determine a first random number; encrypt the first random number by using the second-level key, to obtain an encrypted first random number; generate a first message authentication code based on the second-level key and at least one of a second parameter set and the first random number by using a message authentication code generation function; and send an authentication request message to the network authentication server, where the authentication request message includes the first message authentication code, the encrypted first random number, and the first parameter set;

receive a second message authentication code and an encrypted second random number that are sent by the network authentication server, and decrypt the encrypted second random number based on the second-level key to obtain a second random number, where the encrypted second random number is obtained after the network authentication server encrypts the second random number by using the second-level key; and

after the second message authentication code has been authenticated, generate the communication key of the terminal device based on the second parameter set and at least one of the second-level key, the first random number, and the second random number by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a sixth possible implementation of the eighth aspect, the key receiving module is further configured to receive a first parameter set sent by the user management server; and the authentication module is specifically configured to:

determine a first random number; generate a first message authentication code based on the second-level key and at least one of a second parameter set and the first random number by using a message authentication code generation function; and send an authentication request message to the network authentication server, where the authentication request message includes the first message authentication code, the first random number, and the first parameter set;

receive a second random number and a second message authentication code that are sent by the network authentication server; and

after the second message authentication code has been authenticated, generate the communication key of the terminal device based on the second-level key and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a seventh possible implementation of the eighth aspect, the key receiving module is further configured to receive a first parameter set sent by the user management server; and the authentication module is specifically configured to:

determine a first random number; generate a first message authentication code based on the second-level key and at least one of a second parameter set and the first random number by using a message authentication code generation function; and send an authentication request message to the network authentication server, where the authentication request message includes the first message authentication code, the first random number, and the first parameter set;

receive a second random number, a second message authentication code, and an encrypted communication key that are sent by the network authentication server; and

after the second message authentication code has been authenticated based on the second random number, decrypt the encrypted communication key based on the second-level key to obtain the communication key; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in an eighth possible implementation of the eighth aspect, the key receiving module is further configured to receive a first parameter set sent by the user management server; and the authentication module is specifically configured to:

determine a first random number; encrypt the first random number by using the second-level key, to obtain an encrypted first random number; generate the communication key of the terminal device based on a second parameter set and at least one of the second-level key and the first random number by using a key derivation function; generate a first message authentication code based on either of the second-level key and the communication key and at least one of the second parameter set and the first random number by using a message authentication code generation function; and send an authentication request message to the network authentication server, where the authentication request message includes the first message authentication code, the encrypted first random number, and the first parameter set; and

receive a second message authentication code and an encrypted second random number that are sent by the network authentication server; decrypt the encrypted second random number based on the second-level key to obtain a second random number, where the encrypted second random number is obtained after the network authentication server encrypts the second random number by using the second-level key; and attempt to authenticate the second message authentication code based on the second random number and determine that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a ninth possible implementation of the eighth aspect, the key receiving module is further configured to receive a first parameter set sent by the user management server; and the authentication module is specifically configured to:

determine a first random number; generate the communication key of the terminal device based on the second-level key and at least one of the first random number and a second parameter set by using a key derivation function; generate a first message authentication code based on either of the second-level key and the communication key and at least one of the second parameter set and the first random number by using a message authentication code generation function; and send an authentication request message to the network authentication server, where the authentication request message includes the first message authentication code, the first random number, and the first parameter set; and

receive a second random number and a second message authentication code that are sent by the network authentication server, and attempt to authenticate the second message authentication code and determine that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in a tenth possible implementation of the eighth aspect, the key receiving module is further configured to receive a first parameter set sent by the user management server; and the authentication module is specifically configured to:

determine a first random number and a first transmission parameter of a DH protocol; generate a first message authentication code based on the second-level key, the first random number, and a second parameter set by using a message authentication code generation function; and send an authentication request message to the network authentication server, where the authentication request message includes the first random number, the first transmission parameter, the first message authentication code, and the first parameter set;

receive a second transmission parameter, a second random number, and a second message authentication code that are sent by the network authentication server, and perform a DH key agreement algorithm based on the first transmission parameter and the second transmission parameter to obtain a third transmission parameter; and

after the second message authentication code has been authenticated, generate the communication key of the terminal device based on the third transmission parameter and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

With reference to the eighth aspect, in an eleventh possible implementation of the eighth aspect, the key receiving module is further configured to receive a public key of the terminal device, a first digital signature, and a second parameter set that are sent by the user management server; and the authentication module is specifically configured to:

determine a first random number, encrypt the first random number by using a public key of the network authentication server, to obtain an encrypted first random number, and send an authentication request message to the network authentication server, where the authentication request message includes the public key of the terminal device, the first digital signature, the encrypted first random number, and the second parameter set;

receive an encrypted second random number and a second digital signature that are sent by the network authentication server, and decrypt the encrypted second random number based on the second-level key of the terminal device to obtain a second random number, where the encrypted second random number is obtained after the network authentication server encrypts the second random number by using the public key of the terminal device; and

after the second digital signature has been authenticated, generate the communication key of the terminal device based on the second parameter set and at least one of the first random number and the second random number by using a key derivation function; generate a first message authentication code based on the communication key, the first random number, the second random number, and the second parameter set, or generate a third digital signature based on the second-level key, the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to the eighth aspect, in a twelfth possible implementation of the eighth aspect, the key receiving module is further configured to receive a public key of the terminal device and a second parameter set that are sent by the user management server; and the authentication module is specifically configured to:

determine a first random number, encrypt the first random number by using a public key of the network authentication server, to obtain an encrypted first random number, and send an authentication request message to the network authentication server, where the authentication request message includes the public key of the terminal device, the encrypted first random number, and the second parameter set;

receive an encrypted second random number and a second digital signature that are sent by the network authentication server, and decrypt the encrypted second random number based on the second-level key of the terminal device to obtain a second random number, where the encrypted second random number is obtained after the network authentication server encrypts the second random number by using the public key of the terminal device; and

after the second digital signature has been authenticated, generate the communication key of the terminal device based on the second parameter set and at least one of the first random number and the second random number by using a key derivation function; generate a first message authentication code based on the communication key, the first random number, the second random number, and the second parameter set, or generate a third digital signature based on the second-level key, the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to the eighth aspect, in a thirteenth possible implementation of the eighth aspect, the key receiving module is further configured to receive a public key of the user management server and a second parameter set that are sent by the user management server, where the public key of the user management server is a public key of the terminal device that is corresponding to the second-level key of the terminal device; and the authentication module is specifically configured to:

determine a first random number and a first transmission parameter of a DH protocol, and send an authentication request message to the network authentication server, where the authentication request message includes the public key of the terminal device, the first random number, the first transmission parameter, and the second parameter set;

receive a second transmission parameter, a second random number, and a second digital signature that are sent by the network authentication server, and perform a DH key agreement algorithm based on the first transmission parameter and the second transmission parameter to obtain a third transmission parameter; and

after the second digital signature has been authenticated, generate the communication key of the terminal device based on the third transmission parameter and at least one of the first random number, the second random number, and the second parameter set by using a key derivation function; generate a first message authentication code based on the communication key, the first transmission parameter, the second transmission parameter, and at least one of the first random number, the second random number, and the second parameter set by using a message authentication code generation function, or generate a third digital signature based on the second-level key, the first transmission parameter, the second transmission parameter, and at least one of the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

With reference to any one of the eleventh to the thirteenth possible implementations of the eighth aspect, in a fourteenth possible implementation of the eighth aspect, the server further includes a public key request module, configured to send a public key request message to the network authentication server; and the key receiving module is further configured to receive the public key of the network authentication server that is sent by the network authentication server.

With reference to any one of the eighth aspect, and the first to the fourteenth possible implementations of the eighth aspect, in a fifteenth possible implementation of the eighth aspect, the authentication module is specifically configured to: perform mutual authentication with the network authentication server, and generate a session key of the terminal device based on any one of the communication key, the second parameter set, a random number of the session key, a fresh parameter of the session key, and a preset time parameter of the session key by using the key derivation function.

According to a ninth aspect, an embodiment of the present invention provides a network authentication server, including:

a key obtaining module, configured to: receive an authentication request message sent by a terminal device, where the authentication request message includes a first parameter set, send a second key request message to a service center server, and receive a second-level key sent by the service center server, where the second key request message includes the first parameter set; or receive an authentication request message sent by a terminal device, where the authentication request message includes a first parameter set, send a second key request message to a service center server, receive a first-level key sent by the service center server, and generate a second-level key of the terminal device based on the first-level key and the first parameter set by using a key derivation function; and

an authentication module, configured to perform mutual authentication with the terminal device based on the second-level key, to obtain a communication key for communication between the terminal device and a functional network element; where

the first parameter set includes at least one of a user identifier of a user management server, a device identifier of the terminal device, a network identifier of the user management server, a service parameter, a key random number of the second-level key, a fresh parameter of the second-level key, and a time parameter of the second-level key.

With reference to the ninth aspect, in a first possible implementation of the ninth aspect, the authentication request message further includes an encrypted first random number, and the authentication module is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key;

generate the communication key of the network authentication server based on a second parameter set and at least one of the second-level key, the first random number, and the second random number by using the key derivation function; generate a second message authentication code based on the first random number, the second random number, the second parameter set, and either of the communication key and the second-level key; and send the encrypted second random number and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

With reference to the ninth aspect, in a second possible implementation of the ninth aspect, the authentication request message further includes a first random number, and the authentication module is specifically configured to:

determine a second random number; generate the communication key of the network authentication server based on the second-level key and at least one of the first random number, the second random number, and a second parameter set by using the key derivation function; generate a second message authentication code based on the first random number, the second random number, the second parameter set, and either of the communication key and the second-level key; and send the second random number and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

With reference to the ninth aspect, in a third possible implementation of the ninth aspect, the authentication request message further includes a first random number, and the authentication module is specifically configured to:

determine a second random number; generate the communication key of the network authentication server based on a key random number; encrypt the communication key by using the second-level key, to obtain an encrypted communication key; generate a second message authentication code based on the first random number, the second random number, a second parameter set, and either of the communication key and the second-level key; and send the second random number, the encrypted communication key, and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

With reference to the ninth aspect, in a fourth possible implementation of the ninth aspect, the authentication request message further includes a first transmission parameter and a first random number, and the authentication module is specifically configured to:

determine a second random number and a second transmission parameter of a DH protocol, and perform a DH key agreement algorithm based on the first transmission parameter and the second transmission parameter to obtain a third transmission parameter; and

generate the communication key of the network authentication server based on the third transmission parameter and at least one of the first random number, the second random number, and a second parameter set by using the key derivation function; generate a second message authentication code based on the first transmission parameter, the second transmission parameter, the second parameter set, and either of the communication key and the second-level key; and send the second random number and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

With reference to the ninth aspect, in a fifth possible implementation of the ninth aspect, the authentication request message further includes a first message authentication code and an encrypted first random number, and the authentication module is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key; and

after the first message authentication code has been authenticated, generate the communication key of the network authentication server based on a second parameter set and at least one of the second-level key, the first random number, and the second random number by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

With reference to the ninth aspect, in a sixth possible implementation of the ninth aspect, the authentication request message further includes a first message authentication code and a first random number, and the authentication module is specifically configured to:

determine a second random number; after the first message authentication code has been authenticated, generate the communication key of the network authentication server based on the second-level key and at least one of the first random number, the second random number, and a second parameter set by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

With reference to the ninth aspect, in a seventh possible implementation of the ninth aspect, the authentication request message further includes a first message authentication code and a first random number, and the authentication module is specifically configured to:

determine a second random number; after the first message authentication code has been authenticated, generate the communication key of the network authentication server based on a key random number; encrypt the communication key by using the second-level key, to obtain an encrypted communication key; generate a second message authentication code based on either of the communication key and the second-level key and at least one of the first random number, the second random number, and a second parameter set; and send the second random number, the encrypted communication key, and the second message authentication code to the terminal device, and send the communication key to the functional network element; where

the second parameter set includes at least one of the user identifier of the user management server, the device identifier of the terminal device, the network identifier of the user management server, and the service parameter.

With reference to the ninth aspect, in an eighth possible implementation of the ninth aspect, the authentication request message further includes a first message authentication code and an encrypted first random number, and the authentication module is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key; and

after the first message authentication code has been authenticated, generate the communication key of the terminal device based on a second parameter set and at least one of the second-level key and the first random number by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

With reference to the ninth aspect, in a ninth possible implementation of the ninth aspect, the authentication request message further includes a first message authentication code and a first random number, and the authentication module is specifically configured to:

determine a second random number; after the first message authentication code has been authenticated, generate the communication key of the terminal device based on the second-level key and at least one of the first random number and a second parameter set by using the key derivation function; generate a second message authentication code based on either of the communication key and the second-level key and at least one of the first random number, the second random number, and the second parameter set; and send the second random number and the second message authentication code to the terminal device, and send the communication key to the functional network element; where

the second parameter set includes at least one of the user identifier of the user management server, the device identifier of the terminal device, the network identifier of the user management server, and the service parameter.

With reference to the ninth aspect, in a tenth possible implementation of the ninth aspect, the authentication request message further includes a first message authentication code, a first transmission parameter, and a first random number, and the authentication module is specifically configured to:

determine a second random number and a second transmission parameter of a DH protocol, and perform a DH key agreement algorithm based on the first transmission parameter and the second transmission parameter to obtain a third transmission parameter; and

after the first message authentication code has been authenticated, generate the communication key of the network authentication server based on the third transmission parameter and at least one of the first random number, the second random number, and a second parameter set by using the key derivation function; generate a second message authentication code based on either of the communication key and the second-level key and any one of the first random number, the second random number, the first transmission parameter, the second transmission parameter, and the second parameter set; and send the second random number and the second message authentication code to the terminal device, and send the communication key to the functional network element; where

the second parameter set includes at least one of the user identifier of the user management server, the device identifier of the terminal device, the network identifier of the user management server, and the service parameter.

With reference to any one of the ninth aspect, and the first to the tenth possible implementations of the ninth aspect, in an eleventh possible implementation of the ninth aspect, the authentication module is specifically configured to: perform mutual authentication with the terminal device, generate a session key of the network authentication server based on any one of the communication key, the second parameter set, a random number of the session key, a fresh parameter of the session key, and a preset time parameter of the session key by using the key derivation function, and send the session key to the functional network element.

According to a tenth aspect, an embodiment of the present invention provides a network authentication server, including:

a public key obtaining module, configured to receive an authentication request message sent by a terminal device, where the authentication request message includes a public key of the terminal device; and

an authentication module, configured to perform mutual authentication with the terminal device based on the public key of the terminal device, a public key of the network authentication server, and a private key of the network authentication server, to obtain a communication key for communication between the terminal device and a functional network element.

With reference to the tenth aspect, in a first possible implementation of the tenth aspect, the authentication request message further includes a first digital signature, an encrypted first random number, and a second parameter set, and the authentication module is specifically configured to:

decrypt the encrypted first random number based on the private key of the network authentication server to obtain a first random number, determine a second random number, and encrypt the second random number by using the public key of the terminal device, to obtain an encrypted second random number, where the encrypted first random number is obtained after the terminal device encrypts the first random number by using the public key of the network authentication server;

after the first digital signature has been authenticated, generate the communication key of the network authentication server based on the second parameter set and at least one of the first random number and the second random number by using a key derivation function; generate a second digital signature based on the private key of the network authentication server, the first random number, the second random number, and the second parameter set; and send the second digital signature and the encrypted second random number to the terminal device; and

receive a first message authentication code or a third digital signature sent by the terminal device, and send the communication key to the functional network element after the first message authentication code or the third digital signature has been authenticated; where

the second parameter set includes at least one of a user identifier of a user management server, a device identifier of the terminal device, a network identifier of the user management server, and a service parameter.

With reference to the tenth aspect, in a second possible implementation of the tenth aspect, the authentication request message further includes an encrypted first random number and a second parameter set, and the authentication module is specifically configured to:

decrypt the encrypted first random number based on the private key of the network authentication server to obtain a first random number, determine a second random number, and encrypt the second random number by using the public key of the terminal device, to obtain an encrypted second random number, where the encrypted first random number is obtained after the terminal device encrypts the first random number by using the public key of the network authentication server;

generate the communication key of the network authentication server based on the second parameter set and at least one of the first random number and the second random number by using a key derivation function; generate a second digital signature based on the private key of the network authentication server, the first random number, the second random number, and the second parameter set; and send the encrypted second random number and the second digital signature to the terminal device; and

receive a first message authentication code or a third digital signature sent by the terminal device, and send the communication key to the functional network element after the first message authentication code or the third digital signature has been authenticated; where

the second parameter set includes at least one of a user identifier of a user management server, a device identifier of the terminal device, a network identifier of the user management server, and a service parameter.

With reference to the tenth aspect, in a third possible implementation of the tenth aspect, the authentication request message further includes a first random number, a first transmission parameter, and a second parameter set, and the authentication module is specifically configured to:

determine a second random number and a second transmission parameter of a DH protocol, and perform a DH key agreement algorithm based on the first transmission parameter and the second transmission parameter to obtain a third transmission parameter;

generate the communication key of the network authentication server based on the third transmission parameter and at least one of the first random number, the second random number, and the second parameter set by using a key derivation function; generate a second digital signature based on the private key of the network authentication server, the first transmission parameter, the second transmission parameter, and at least one of the first random number, the second random number, and the second parameter set; and send the second random number, the second transmission parameter, and the second digital signature to the terminal device; and

receive a first message authentication code or a third digital signature sent by the terminal device, and send the communication key to the functional network element after the first message authentication code has been authenticated or after the third digital signature has been authenticated based on the public key of the terminal device; where

the second parameter set includes at least one of a user identifier of a user management server, a device identifier of the terminal device, a network identifier of the user management server, and a service parameter.

With reference to any one of the tenth aspect, and the first to the third possible implementations of the tenth aspect, in a fourth possible implementation of the tenth aspect, the server further includes: a public key request receiving module, configured to receive a public key request message sent by the terminal device; and

a public key sending module, configured to send the public key of the network authentication server to the terminal device.

With reference to any one of the tenth aspect, and the first to the fourth possible implementations of the tenth aspect, in a fifth possible implementation of the tenth aspect, the authentication module is specifically configured to: perform mutual authentication with the terminal device, generate a session key of the network authentication server based on any one of the communication key, the second parameter set, a random number of the session key, a fresh parameter of the session key, and a preset time parameter of the session key by using the key derivation function, and send the session key to the functional network element.

According to an eleventh aspect, an embodiment of the present invention provides a storage medium, where the storage medium is a computer-readable storage medium storing one or more programs, the one or more programs include instructions, and when the instruction is executed by an electronic device including a plurality of application programs, the electronic device executes the key distribution method in any one of the first aspect, and the first to the fourth possible implementations of the first aspect.

According to a twelfth aspect, an embodiment of the present invention provides a storage medium, where the storage medium is a computer-readable storage medium storing one or more programs, the one or more programs include instructions, and when the instruction is executed by an electronic device including a plurality of application programs, the electronic device executes the key distribution method in any one of the second aspect, and the first to the seventh possible implementations of the second aspect.

According to a thirteenth aspect, an embodiment of the present invention provides a storage medium, where the storage medium is a computer-readable storage medium storing one or more programs, the one or more programs include instructions, and when the instruction is executed by an electronic device including a plurality of application programs, the electronic device executes the key authentication method in any one of the third aspect, and the first to the fifteenth possible implementations of the third aspect.

According to a fourteenth aspect, an embodiment of the present invention provides a storage medium, where the storage medium is a computer-readable storage medium storing one or more programs, the one or more programs include instructions, and when the instruction is executed by an electronic device including a plurality of application programs, the electronic device executes the key authentication method in any one of the fourth aspect, the first to the eleventh possible implementations of the fourth aspect, the fifth aspect, and the first to the fifth possible implementations of the fifth aspect.

According to a fifteenth aspect, an embodiment of the present invention provides a key distribution and authentication system, including: the service center server in any one of the sixth aspect, and the first to the seventh possible implementations of the sixth aspect; the user management server in any one of the seventh aspect, the first possible implementation of the seventh aspect, and the second possible implementation of the seventh aspect; the terminal device in any one of the eighth aspect, and the first to the fifteenth possible implementations of the eighth aspect; and the network authentication server in any one of the ninth aspect, the first to the eleventh possible implementations of the ninth aspect, the tenth aspect, and the first to the fifth possible implementations of the tenth aspect.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show some embodiments of the present invention, and a person of ordinary skill in the art may derive other drawings from these accompanying drawings without creative efforts.

FIG. 1 is a schematic diagram of a system architecture in Embodiment 1 of a key distribution and authentication method according to the present invention;

FIG. 2 is a signaling flowchart of Embodiment 1 of a key distribution and authentication method according to the present invention;

FIG. 3 is a signaling flowchart of Embodiment 1 of a key authentication method according to the present invention:

FIG. 4 is a signaling flowchart of Embodiment 2 of a key authentication method according to the present invention:

FIG. 5 is a signaling flowchart of Embodiment 3 of a key authentication method according to the present invention;

FIG. 6 is a signaling flowchart of Embodiment 4 of a key authentication method according to the present invention:

FIG. 7 is a signaling flowchart of Embodiment 5 of a key authentication method according to the present invention:

FIG. 8 is a signaling flowchart of Embodiment 6 of a key authentication method according to the present invention;

FIG. 9 is a signaling flowchart of Embodiment 7 of a key authentication method according to the present invention;

FIG. 10 is a signaling flowchart of Embodiment 8 of a key authentication method according to the present invention;

FIG. 11 is a signaling flowchart of Embodiment 9 of a key authentication method according to the present invention:

FIG. 12 is a signaling flowchart of Embodiment 10 of a key authentication method according to the present invention;

FIG. 13 is a signaling flowchart of Embodiment 11 of a key authentication method according to the present invention;

FIG. 14 is a signaling flowchart of Embodiment 12 of a key authentication method according to the present invention:

FIG. 15 is a signaling flowchart of Embodiment 13 of a key authentication method according to the present invention:

FIG. 16 is a schematic structural diagram of Embodiment 1 of a user management server according to the present invention;

FIG. 17 is a schematic structural diagram of Embodiment 1 of a service center server according to the present invention;

FIG. 18 is a schematic structural diagram of Embodiment 1 of a terminal device according to the present invention;

FIG. 19 is a schematic structural diagram of Embodiment 1 of a network authentication server according to the present invention; and

FIG. 20 is a schematic structural diagram of Embodiment 2 of a network authentication server according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

The terms “include”, “contain” and any other variants in the specification and claims of the present invention mean to cover the non-exclusive inclusion, for example, a process, method, system, product, or device that includes a list of steps or units is not necessarily limited to those steps or units, but may include other steps or units not expressly listed or inherent to such a process, method, product, or device.

The embodiments of the present invention provide a key distribution and authentication method and a device, so as to distribute a key to a terminal device, so that the terminal device performs mutual authentication with a network authentication server based on the distributed key to obtain a communication key, and then the terminal device can connect to a communications network based on the communication key and perform secure communication. The following uses specific embodiments to describe in detail a system architecture for key distribution and authentication in the embodiments of the present invention.

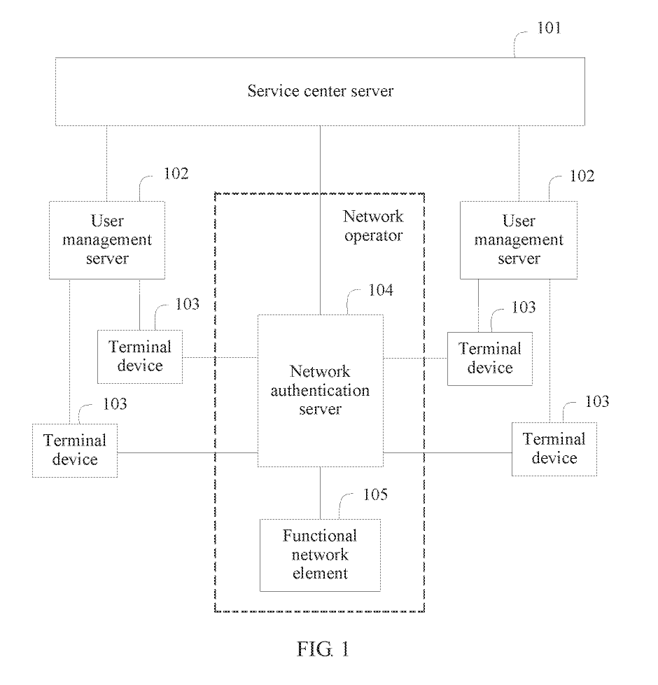

FIG. 1 is a schematic diagram of a system architecture in Embodiment 1 of the key distribution and authentication method according to the present invention. As shown in FIG. 1, the system architecture includes a service center server 101, a user management server 102, a terminal device 103, a network authentication server 104, and a functional network element 105. The service center server 101 is configured to securely generate and allocate a first-level key to the user management server 102. When the user management server 102 sends a first key request message, the service center server 101 allocates different first-level keys to different user management servers 102 based on different user identifiers of the user management servers 102. The service center server 101 may also distribute keys of different types or with different security levels for different service types of the user management server 102 by using different algorithms. The service center server 101 may be controlled by a network operator, or may be controlled by a third party independent of the network operator and the user management server. The service center server 101 may be specifically a server, a base station, a workstation, a computer, a gateway, and the like. That the service center server 101 is a server is merely used as an example rather than a limitation in this embodiment of the present invention. The user management server 102 may be a company or an enterprise, or may be an end user or a terminal, and one or more terminal devices 103 are deployed for the user management server 102. In an example shown in FIG. 1, one user management server 102 manages two terminal devices 103. A person skilled in the art should understand that this imposes no limitation on the embodiments of the present invention. The user management server 102 is configured to securely generate and allocate a second-level key to the terminal device 103 managed by the user management server 102. After receiving a first-level key sent by the service center server 101, the user management server 102 generates different second-level keys based on different device identifiers of terminal devices 103. The user management server 102 may also distribute second-level keys of different types or with different security levels for different service types of the terminal device 103 by using different algorithms. The terminal device 103 may be an intelligent device such as a mobile phone, a tablet computer, or an intelligent terminal, or may be a communications device such as a server, or may be an Internet of Things device such as a sensor, an electricity meter, or a water meter. The network authentication server 104 and the functional network element 105 are controlled by a network operator. The network authentication server 104 is configured to perform mutual authentication with the terminal device 103 based on a distributed second-level key to obtain a communication key. The network authentication server 104 may be specifically a mobility management entity (Mobility Management Entity, MME for short), a home subscriber server (Home Subscriber Server, HSS for short), a controller, a control node, a gateway, a server, or the like. The functional network element 105 is configured to implement secure communication with the terminal device 103 based on a communication key obtained in an authentication process. The functional network element 105 may be specifically a data plane anchor used by the terminal device 103 to access a communications network, or may be a core network server, a control node, or a user plane gateway such as a PDH device, an SDH-ADM, a DACS, a TEM, an RE and a PCM.

Optionally, the service center server 101 includes a service authentication server and a key management server. For example, the service authentication server communicates with the user management server 102, and the key management server communicates with the network authentication server 104; the service authentication server receives a first key request message sent by the user management server 102, and forwards the first key request message to the key management server; when the key management server generates a first-level key, the key management server sends the first-level key to the user management server 102 by using the service authentication server; the user management server 102 generates a second-level key based on the first-level key, and sends the second-level key to the terminal device 103; and when the terminal device 103 and the network authentication server 104 perform mutual authentication based on a symmetric key technology, the key management server may directly send the first-level key to the network authentication server 104, so that the network authentication server 104 generates the second-level key based on the first-level key. Alternatively, the service authentication server may communicate with the network authentication server 104, and the key management server directly communicates with the user management server 102; the key management server directly receives a first key request message sent by the user management server 102, and directly sends a generated first-level key to the user management server 102; and when the terminal device 103 and the network authentication server 104 perform mutual authentication based on a symmetric key technology, the key management server sends the first-level key to the network authentication server 104 by using the service authentication server. Alternatively, the service authentication server may communicate with the user management server 102 and the network authentication server 104, the key management server communicates with only the service authentication server, and the service authentication server directly communicates with the user management server 102; the service authentication server directly receives a first key request message sent by the user management server 102, and directly sends a first-level key generated by the key management server to the user management server 102; and when the terminal device 103 and the network authentication server 104 perform mutual authentication based on a symmetric key technology, the service authentication server sends the first-level key to the network authentication server 104.

On the basis of the foregoing system architecture, the following describes in detail, by using specific embodiments, the technical solutions of the present invention and methods for implementing the technical solutions of the present invention. The following specific embodiments may be combined with each other, and a same or similar concept or process may not be described repeatedly in some embodiments.

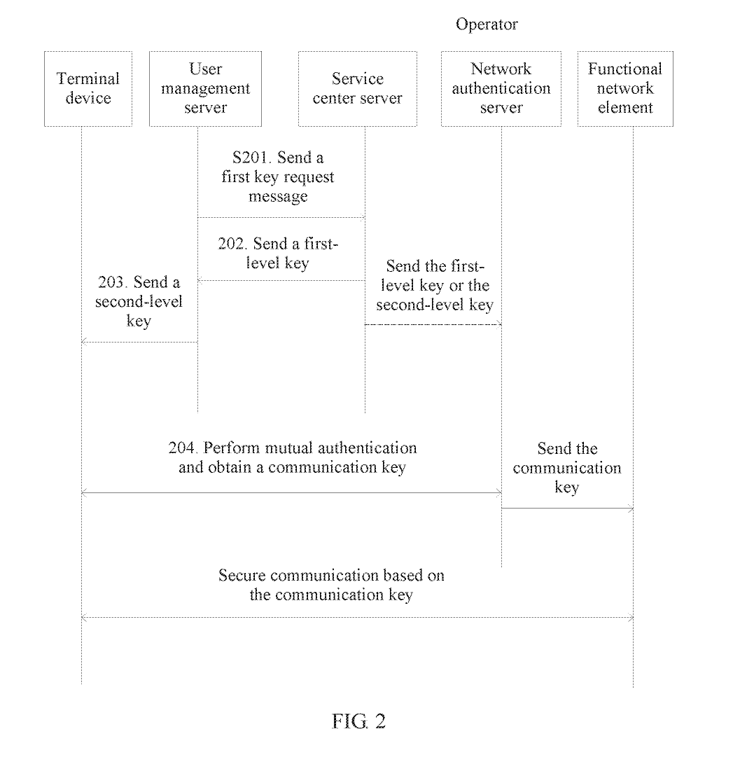

FIG. 2 is a signaling flowchart of Embodiment 1 of a key distribution and authentication method according to the present invention. As shown in FIG. 2, the method includes the following steps.

S201. A user management server sends a first key request message to a service center server.

The first key request message is used to instruct the service center server to generate a first-level key of the user management server, where the first key request message includes a user identifier of the user management server.

Specifically, before step 201, the user management server and the service center server have performed mutual authentication and the mutual authentication succeeds, and a secure communication channel is established. For example, the authentication may be performed in a manner such as a user name password, a certificate, a symmetric key, the AKA protocol, or the like.

S202. The service center server receives the first key request message sent by the user management server, generates a first-level key of the user management server, and sends the first-level key to the user management server.

Specifically, when receiving the first key request message sent by the user management server, the service center server generates the first-level key and sends the first-level key to the user management server, so that the user management server generates a second-level key of a terminal device based on the first-level key. For example, first key request messages sent by different user management servers to the service center server include user identifiers of the user management servers, and the service center server generates one first-level key for a user management server indicated by a user identifier included in each first key request message. For example, that the service center server generates the first-level key of the user management server includes the following feasible implementations.

In a first feasible implementation, a key generation process based on a symmetric key technology includes:

the service center server generates the first-level key of the user management server based on a third parameter set by using a key derivation function; or

the service center server determines a service random number and uses the service random number as the first-level key of the user management server; or

when the first key request message further includes at least one of a network identifier of the user management server and a service parameter, the service center server generates the first-level key of the user management server based on a fourth parameter set by using a key derivation function.

The third parameter set includes at least one of a key random number of the first-level key, a fresh parameter of the first-level key, a time parameter of the first-level key, and a shared key, and the shared key is a key shared by the user management server and the service center server.

The fourth parameter set includes at least one of the user identifier of the user management server, the network identifier of the user management server, the service parameter, the key random number of the first-level key, the fresh parameter of the first-level key, the time parameter of the first-level key, and the shared key, and the shared key is a key shared by the user management server and the service center server.

In the first feasible implementation, the service center server sends the first-level key to the user management server, and the user management server generates the second-level key based on the first-level key and sends the second-level key to the terminal device.

To enable the terminal device and the network authentication server to perform mutual authentication based on the symmetric key technology, the service center server may send the first-level key to the network authentication server, so that the network authentication server generates, based on the first-level key, a second-level key that is the same as the second-level key of the terminal device.

Specifically, the service center server receives a second key request message sent by the network authentication server, where the second key request message includes the user identifier of the user management server; and the service center server retrieves or generates the first-level key based on the user identifier of the user management server in the second key request message, and sends the first-level key to the network authentication server, so that the network authentication server generates the second-level key of the terminal device based on the first-level key, and performs mutual authentication with the terminal device based on the second-level key.

The service center server may store the user identifier of the user management server and the first-level key in a corresponding manner. In this way, each time receiving a key request message including the user identifier, the service center server can regenerate, based on the user identifier, the first-level key of the user management server corresponding to the current user identifier.

Alternatively, the service center server may first generate, based on the first-level key, a second-level key that is the same as the second-level key of the terminal device for the network authentication server, and sends the second-level key to the network authentication server.

Specifically, the service center server receives a second key request message sent by the network authentication server, where the second key request message includes a first parameter set; and the service center server generates the second-level key of the terminal device based on the first-level key and the first parameter set by using the key derivation function, and sends the second-level key to the network authentication server, so that the network authentication server performs mutual authentication with the terminal device based on the second-level key.

The first parameter set includes parameters used when the user management server generates second-level keys for different terminal devices. To ensure that the second-level key of the terminal device and the second-level key of the network authentication server are the same, the first parameter set needs to be sent to the network authentication server or the service center server depending on a server generating the second-level key.

The first parameter set includes at least one of the user identifier of the user management server, the device identifier of the terminal device, the network identifier of the user management server, the service parameter, a key random number of the second-level key, a fresh parameter of the second-level key, and a time parameter of the second-level key.

After receiving the second-level key sent by the user management server, the terminal device may perform mutual authentication with the network authentication server based on the symmetric key technology. Because the second-level key is possessed by only the terminal device and the network authentication server, and is not disclosed, the terminal device and the network authentication server may encrypt and decrypt data based on the second-level key, thereby ensuring confidentiality of the authentication process.

In the first feasible implementation, the key derivation function (Key Derivation Function, KDF for short) is used to obtain a key through derivation based on an input parameter, and different keys are obtained when content, quantities, and sequences of input parameters are different. Specifically, an algorithm used by the KDF may be an HMAC algorithm (for example, HMAC-sha256), an OMAC algorithm, a CBC-MAC algorithm, a PMAC algorithm, a UMAC algorithm, a VMAC algorithm, or the like.

In the first feasible implementation, the key shared by the user management server and the service center server may be preset, or may be a key negotiated after a user and a key management center perform a protocol such as IPsec or TLS, or may be a key (for example, Kasme, a CK, and an IK) obtained after a user and a key management center perform AKA authentication and the authentication succeeds.

In a second feasible implementation, a key generation process based on identity-based cryptography or hierarchical identity-based cryptography includes:

the service center server generates the first-level key of the user management server based on the user identifier of the user management server by using a key generation algorithm in identity-based cryptography;

or

the service center server generates the first-level key of the user management server based on the user identifier of the user management server and a fifth parameter set by using a key generation algorithm in identity-based cryptography.

The first-level key is a private key of the user management server, and the user identifier of the user management server is a public key of the user management server. Optionally, a public key generated based on the user identifier of the user management server may be selected as a public key of the user management server. In the following embodiments, that the user identifier of the user management server is used as the public key of the user management server is used as an example rather than a limitation. The fifth parameter set includes at least one of the following: a key random number of the first-level key, a fresh parameter of the first-level key, a time parameter of the first-level key.

In the second implementation, different private keys of user management servers and public keys of the user management servers that are corresponding to the private keys of the user management servers are generated for the different user management servers based on user identifiers of the different user management servers by using the key generation algorithm in the identity-based cryptography. When the user management server generates the second-level key for the terminal device based on the private key of the user management server, a private key of the terminal device and a public key of the terminal device are also obtained. In addition, the network authentication server also has a public key and a private key based on the identity-based cryptography. The public key is disclosed data, and the private key of the terminal device is possessed by only the terminal device and is not disclosed. When a device encrypts data by using the public key of the terminal device, and sends encrypted data to the terminal device, the terminal device may decrypt the encrypted data by using the private key of the terminal device, to obtain the data. Even if another device obtains the encrypted data, the another device cannot correctly decrypt or authenticate the encrypted data because the another device does not have the private key of the terminal device. Therefore, this kind of key based on the identity-based cryptography is applicable to a mutual authentication process based on an identity key technology. In a mutual authentication process, the public key and the private key based on the identity-based cryptography may be preset in the network authentication server.

In a third feasible implementation, a key generation process based on privacy-enhancing technologies includes:

the service center server generates a private key of the user management server and a public key of the user management server by using the privacy-enhancing technologies, where

the private key of the user management server is the first-level key of the user management server, and the service center server further sends the public key of the user management server to the user management server.

The privacy-enhancing technologies may be used to generate, based on user identifiers of different user management servers, different private keys for the different user management servers and public keys of the user management servers that are corresponding to the private keys of the user management servers. When the user management server generates a private key of the terminal device, namely the second-level key, for the terminal device based on the private key of the user management server, the terminal device may generate a digital signature based on the second-level key. A receiver can authenticate the digital signature of the terminal device by using only the public key of the user management server. Different from the second implementation, in the third implementation, the terminal device does not have the public key of the terminal device, and only have the public key of the user management server.

In any one of the foregoing feasible implementations, the fresh parameter (for example, a serial number or a nonce) of the first-level key is used to indicate freshness of the first-level key and prevent a replay attack. Fresh parameters of the first-level key at different moments should be different, and if fresh parameters of the first-level key at different moments are the same, it may be considered that a replay attack is carried out. The preset time parameter of the first-level key is used to indicate a validity period of the first-level key and includes at least one of a time point at which the first-level key becomes valid, a time point at which the first-level key becomes invalid, and a period during which the first-level key remains valid. A fresh parameter of any key in the following embodiments has the same meaning, and details are not described repeatedly.

The user identifier of the user management server includes but is not limited to at least one of the following: an industry user ID, a company identifier ID, a service ID, and an individual user ID (for example, an IMEI, an IMSI, an IMPI, a TMSI, an IMPU, a user app ID, a MAC address, an IP address, a phone number, and a GUTI).

The network identifier includes but is not limited to at least one of the following: an operator ID (PLMN ID), an access network ID (Access Network ID), a serving network ID (Serving Network ID), a local area network ID, and another network ID.

The service parameter includes but is not limited to at least one of the following: a serial number SN in a service, a time stamp, a related ID in the service, a service fresh parameter, a service random number (nonce′/random number 1), a service class, and a delay parameter. The related ID in the service may be a service name, including at least one of an ID of a key management center, an ID of a service authentication center, an ID of a service center, a session ID, a link ID, an application ID, and a server ID. The time stamp may be a user's system time at which the request message is sent.

The device identifier of the terminal device includes but is not limited to at least one of the following: a device number, a serial number, an IMEI, an IMSI, an IMPI, a TMSI, an IMPU, a device app ID, a MAC address, an IP address, a phone number, and a GUTI. Optionally, the device identifier may also be another possible identifier that uniquely identifies the device.

In any one of the foregoing manners for generating the first-level key, different parameters are generally used to generate different first-level keys for different user management servers. For example, network identifiers of user management servers and service parameters may be added in a process of generating first-level keys, so as to generate first-level keys with different levels of complexity for different services of different user management servers. In other words, the service center server may set first-level keys with different levels of complexity for different user management servers. When different services of one user management server request keys from the service center server, the service center server may set a plurality of first-level keys for the user management server, so that the different services of the user management server are protected by using different keys.

S203. The user management server generates a second-level key of a terminal device based on the first-level key, and sends the second-level key to the terminal device.

Specifically, the user management server receives the first-level key sent by the service center server, generates the second-level key of the terminal device based on the first-level key, and sends the second-level key to the terminal device, so that the terminal device performs mutual authentication with the network authentication server based on the second-level key, to obtain a communication key for communication between the terminal device and a functional network element.

For example, when the user management server manages a plurality of terminal devices, the user management server generates different second-level keys for different terminal devices based on device identifiers of the terminal devices. Further, a parameter used for generating the second-level key may be added, so that the second-level keys can have higher confidentiality and have different secret levels. The user management server generates second-level keys for different terminal devices, so that load of the service center server in key generation can be greatly reduced.

Optionally, when the service center server sends the first-level key to the user management server and when the user management server sends the second-level key to the terminal device, time information of the keys is sent at the same time, so as to limit valid available time periods of the keys.

For example, that the user management server generates the second-level key of the terminal device includes the following feasible implementations.

In a first feasible implementation, a key generation process based on a symmetric key technology includes:

generating, by the user management server, the second-level key of the terminal device based on the first-level key and the first parameter set by using the key derivation function.

The method is applied to a case in which the first-level key is generated based on the symmetric key technology. Specifically, the user management server sends the second-level key and the first parameter set to the terminal device.

The first parameter set includes at least one of the user identifier of the user management server, the device identifier of the terminal device, the network identifier of the user management server, the service parameter, the key random number of the second-level key, the fresh parameter of the second-level key, and the time parameter of the second-level key.

In a second feasible implementation, a key generation process based on the identity key technology includes:

the user management server generates the second-level key of the terminal device and the public key of the terminal device based on the private key of the user management server and the first parameter set.

Specifically, the first-level key is the private key of the user management server, and the second-level key is the private key of the terminal device that is corresponding to the public key of the terminal device. The user management server further generates a first digital signature based on the first-level key, the public key of the terminal device, and the first parameter set, and sends the public key of the terminal device, the second-level key, the first digital signature, and a second parameter set to the terminal device. The public key of the terminal device may be the device identifier of the terminal device.

The method is applied to a case in which the first-level key is generated based on the identity key technology. The first parameter set includes at least one of the user identifier of the user management server, the device identifier of the terminal device, the network identifier of the user management server, the service parameter, the key random number of the second-level key, the fresh parameter of the second-level key, and the time parameter of the second-level key. The second parameter set includes at least one of the user identifier of the user management server, the device identifier of the terminal device, the network identifier of the user management server, and the service parameter.

In a third feasible implementation, a key generation process based on a hierarchical identity key technology includes:

the user management server generates the second-level key of the terminal device based on the first-level key and the device identifier of the terminal device by using a device identity-based generation algorithm.

Specifically, the first-level key is the private key of the user management server, and the second-level key is the private key of the terminal device. The user management server sends, to the terminal device, a second parameter set, the second-level key, and the public key of the terminal device that is corresponding to the private key of the terminal device. The public key of the terminal device may be the device identifier of the terminal device.

The method is applied to a case in which the first-level key is generated based on the identity key technology. The second parameter set includes at least one of the user identifier of the user management server, the device identifier of the terminal device, the network identifier of the user management server, and the service parameter.

In a fourth feasible implementation, a key generation process based on the privacy-enhancing technologies includes:

the user management server generates the second-level key of the terminal device based on the private key of the user management server by using a key generation algorithm in the privacy-enhancing technologies.

Specifically, the first-level key is the private key of the user management server, and the second-level key is the private key of the terminal device. The user management server sends the public key of the user management server, the second-level key, and a second parameter set to the terminal device. The public key of the user management server is a public key corresponding to the private key of the terminal device.

The method is applied to a case in which the first-level key is generated based on the privacy-enhancing technologies. The second parameter set includes at least one of the user identifier of the user management server, the device identifier of the terminal device, the network identifier of the user management server, and the service parameter.

S204. The terminal device performs mutual authentication with a network authentication server to obtain a communication key.

Specifically, the terminal device receives the second-level key sent by the user management server, and performs mutual authentication with the network authentication server to obtain the communication key for communication between the terminal device and the functional network element.

Optionally, after step 204, this embodiment of the present invention further includes:

the network authentication server sends the communication key to the functional network element, so that the terminal device and the functional network element can perform secure communication based on the communication key.

Optionally, in this embodiment of the present invention, after the communication key is generated, the network authentication server and the terminal device may generate a session key based on any one of the shared communication key, the second parameter set, a random number of the session key, a fresh parameter of the session key, and a preset time parameter of the session key by using the key derivation function, and send the session key to the functional network element, so as to use the session key instead of the communication key to implement secure communication between the functional network element and the terminal device.

Step 201 to step 203 mainly describe a key distribution method, and step 204 mainly describes a key authentication process.

Specifically, in step 204, based on different manners for generating the second-level key of the terminal device, mutual authentication between the terminal device and the network authentication server includes the following feasible implementations.

In a feasible implementation, the terminal device and the network authentication server perform mutual authentication based on the symmetric key technology.

In this feasible implementation, the service center server sends the first-level key of the user management server to the user management server, and the user management server generates the second-level key based on the first-level key; meanwhile, the network authentication server receives the first-level key or the second-level key sent by the service center server, and when the network authentication server receives the first-level key, the network authentication server generates the second-level key based on the first-level key, where a specific generation method is the same as a manner in which the user management server generates the second-level key, and details are not described; and finally, the network authentication server performs mutual authentication with the terminal device based on the second-level key.

For example, as shown in the dashed line in FIG. 2, the service center server may send the first-level key or the second-level key to the network authentication server when or after sending the first-level key to the user management server. Optionally, the service center server may send the first-level key or the second-level key to the network authentication server after receiving the second key request message sent by the network authentication server.

For example, in the process of mutual authentication between the network authentication server and the terminal device, the network authentication server may send the second key request message to the service center server after receiving an authentication request message sent by the terminal device, and the service center server sends the first-level key to the network authentication server after receiving the second key request message.

In another feasible implementation, the terminal device and the network authentication server perform mutual authentication based on an asymmetric key technology.

In this feasible implementation, the second-level key of the terminal device is the private key of the terminal device, and the device identifier of the terminal device is the public key of the terminal device. Optionally, a public key generated based on the device identifier of the terminal device may be selected as the public key of the terminal device. Details are not described in the following embodiments.

In this case, the network authentication server obtains the public key of the terminal device after receiving an authentication request message sent by the terminal device. To be specific, the network authentication server stores the public key of the terminal device, the public key of the network authentication server, and the private key of the network authentication server, and the terminal device stores the public key of the network authentication server. The network authentication server may encrypt to-be-transmitted data based on the public key of the terminal device, and the terminal device may encrypt to-be-transmitted data based on the public key of the network authentication server, so that the terminal device and the network authentication server can perform mutual authentication and obtain the communication key in a confidential situation.

For example, the public key and the private key of the network authentication server are generated based on the identity-based cryptography. The public key of the network authentication server may be an ID of the network authentication server, or a public key generated based on an ID of the network authentication server is used as the public key of the network authentication server.

For example, the public key of the network authentication server may be prestored in the terminal device. For example, the public key of the network authentication server may also be obtained before mutual authentication between the network authentication server and the terminal device. The network authentication server receives a public key request message or a certificate request message sent by the terminal device, and then the network authentication server sends the public key of the network authentication server or a certificate of the network authentication server to the terminal device. The certificate includes the public key of the network authentication server.

For example, the network authentication server may send the public key of the network authentication server to the terminal device in the mutual authentication process.

The network authentication server may also generate a third public key and a third private key of the network authentication server based on public key infrastructure (Public Key Infrastructure, PKI for short) cryptography, so as to replace the public key and the private key that are generated by the network authentication server based on the identity-based cryptography.

Optionally, the terminal device and the network authentication server may perform mutual authentication according to a protocol such as IPsec or TLS. Optionally, the terminal device and the network authentication server may directly use the second-level key as a key for secure communication between the terminal device and the functional network element.

In particular, this embodiment of the present invention is applicable to key distribution and authentication when an enterprise or a company simultaneously manages a plurality of terminal devices based on a plurality of services. According to this embodiment of the present invention, a plurality of terminal devices can obtain, in a case in which the terminal devices have not preset root keys or do not support a USIM card, different keys distributed by the service center server based on different services processed by the terminal devices, so that secure communication can be implemented. In addition, service-based key distribution and authentication led by an enterprise or a company are implemented, and operation complexity of the operator is reduced.

In the key distribution and authentication method provided in this embodiment of the present invention, the service center server distributes different keys to user management servers, the user management servers distribute different keys to terminal devices, and the terminal devices perform mutual authentication with the network authentication server based on respective keys, and finally obtain communication keys for communication between the terminal devices and the functional network element. This embodiment of the present invention provides a method for establishing a secure communication channel for the terminal device, has a broad application range, and reduces operator network complexity.

The following describes in detail the mutual authentication process in step 204 by using specific embodiments. As described above, mutual authentication manners include at least an authentication manner based on the symmetric key technology and an authentication manner based on the asymmetric key technology.

In the authentication manner based on the symmetric key technology, the terminal device further receives the first parameter set sent by the user management server. Specifically, the mutual authentication process includes the following possible implementations.

First Possible Authentication Implementation:

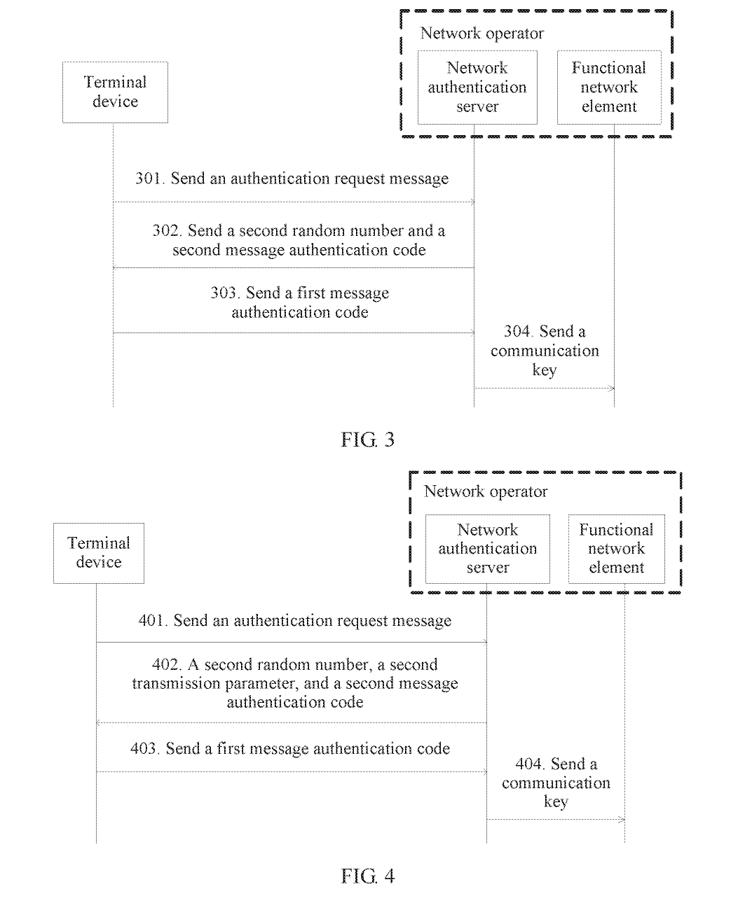

FIG. 3 is a signaling flowchart of Embodiment 1 of a key authentication method according to the present invention. As shown in FIG. 3, the method includes the following steps.

S301. The terminal device sends an authentication request message to the network authentication server.

Specifically, the terminal device determines a first random number, encrypts the first random number by using the second-level key, to obtain an encrypted first random number, and sends the authentication request message to the network authentication server, where the authentication request message includes the first parameter set and the encrypted first random number.

S302. The network authentication server sends an encrypted second random number and a second message authentication code to the terminal device.

Specifically, the network authentication server decrypts the encrypted first random number based on the second-level key to obtain the first random number; determines a second random number, and encrypts the second random number by using the second-level key, to obtain the encrypted second random number; generates a communication key K_com of the network authentication server based on the second parameter set and at least one of the second-level key K_dev, the first random number (nonce 1), and the second random number (nonce 2) by using the key derivation function, that is, K_com=KDF ((at least one of K_dev, nonce 1, and nonce 2), and the second parameter set); generates the second message authentication code MAC 2 based on the first random number (nonce 1), the second random number (nonce 2), the second parameter set, and either of the communication key K_com and the second-level key K_dev, that is, MAC 2=MAC ((K_com or K_dev), nonce 1, nonce 2, and the second parameter set); and sends the encrypted second random number and the second message authentication code to the terminal device.

S303. The terminal device sends a first message authentication code to the network authentication server.

Specifically, the terminal device receives the encrypted second random number and the second message authentication code that are sent by the network authentication server; decrypts the encrypted second random number based on the second-level key to obtain the second random number; after the second message authentication code has been authenticated, generates the communication key K_com of the terminal device based on the second parameter set and at least one of the second-level key K_dev, the first random number (nonce 1), and the second random number (nonce 2) by using the key derivation function KDF, that is, K_com=KDF ((at least one of K_dev, nonce 1, and nonce 2), and the second parameter set); generates the first message authentication code MAC 1 based on the first random number, the second random number, the second parameter set, and either of the communication key K_com and the second-level key K_dev, for example, MAC 1=MAC ((K_com or K_dev), and (at least one of nonce 1, nonce 2, and the second parameter set)); and sends the first message authentication code to the network authentication server.

S304. The network authentication server receives the first message authentication code sent by the terminal device, and sends the communication key to a functional network element after the network authentication server has authenticated the first message authentication code.

Optionally, in a process of implementing the foregoing authentication manner, the second parameter set is added in the processes of generating the communication key and the message authentication code, so as to improve confidentiality and increase relevance between the communication key and the terminal device. The second parameter set includes at least one of the user identifier of the user management server, the device identifier of the terminal device, the network identifier of the user management server, and the service parameter. Optionally, in a process of implementing the foregoing authentication manner, the second parameter set may be omitted in the processes of generating the communication key and the message authentication code, so as to simplify the communication key.

The first parameter set and the second parameter set in the embodiments of this application are the same, and therefore details are not described in the following.

Optionally, in the foregoing process of generating the communication key, a key parameter of the communication key may be used to replace the second parameter set. Alternatively, both the key parameter of the communication key and the second parameter set may be used. The key parameter of the communication key includes at least one of the following: a random number of the communication key, a fresh parameter of the communication key, and a preset time parameter of the communication key. A person skilled in the art clearly understands that adding another similar parameter, deleting some parameters, or replacing the parameter in this application with another similar parameter also falls within the protection scope of the present invention. Specifically, in the foregoing mutual authentication process, when the key parameter of the communication key is used in the process of generating the communication key by the network authentication server, the network authentication server needs to send the key parameter of the communication key to the terminal device; when the key parameter of the communication key is not used in the process of generating the communication key by the network authentication server, the network authentication server does not need to send the key parameter of the communication key to the terminal device.

Specifically, in the foregoing authentication process, the first message authentication code and the second message authentication code may be encrypted based on the second-level key, so as to improve confidentiality of the authentication process. Specifically, in the process of generating the communication key K_com, if the second-level key shared by the terminal device and the network authentication server is used to generate K_com, the first random number or the second random number may not be encrypted in the mutual authentication process. In the foregoing authentication process, the terminal device and the network authentication server use the same key derivation function and parameters to generate the communication key of the terminal device. In a process of generating a message authentication code, the terminal device and the network authentication server may use different parameters or parameters in different sequences to obtain different message authentication codes.

The same settings described above or similar settings may also be used in the following possible authentication manners, and details are not described in the following.

Optionally, the communication key in step S302 may be obtained by the network authentication server based on a third random number. When the communication key is obtained based on the third random number, the network authentication server encrypts the communication key by using the second-level key, and sends an encrypted communication key to the terminal device, so that the terminal device can obtain the communication key after decrypting the encrypted communication key. Optionally, the first random number and the second random number may not be encrypted in a process of randomly generating the communication key.

Second Possible Authentication Implementation:

FIG. 4 is a signaling flowchart of Embodiment 2 of a key authentication method according to the present invention. As shown in FIG. 4, the method includes the following steps.

S401. The terminal device sends an authentication request message to the network authentication server.

Specifically, the terminal device determines a first random number and a first transmission parameter of a DH protocol. For example, the terminal device may first determine a first parameter x, and obtain the first transmission parameter g^{x} of the DH protocol based on the first parameter x. The first transmission parameter g^{x} is a generator g of the preset DH protocol raised to the power of the first parameter. Then the terminal device sends the authentication request message to the network authentication server. The authentication request message includes the first random number, the first transmission parameter, and the first parameter set.

The DH protocol in the embodiments of the present invention is the Diffie-Hellman protocol.

S402. The network authentication server sends a second random number, a second transmission parameter, and a second message authentication code to the terminal device.

Specifically, the network authentication server receives the first random number, the first transmission parameter, and the first parameter set, and determines the second random number and the second transmission parameter of the DH protocol. For example, the network authentication server may first determine a second parameter y, and obtain the second transmission parameter g^{y} based on the second parameter y. The second transmission parameter g^{y} is a generator g of the preset DH protocol raised to the power of the second parameter. Then the network authentication server performs a DH key agreement algorithm based on the first transmission parameter g^{x} and the second transmission parameter g^{y} to obtain a third transmission parameter g^{xy}; generates the communication key of the network authentication server based on the third transmission parameter and at least one of the first random number, the second random number, and the second parameter set by using the key derivation function; generates the second message authentication code based on the first transmission parameter, the second transmission parameter, the second parameter set, and either of the communication key and the second-level key and sends the second random number and the second message authentication code to the terminal device.

S403. The terminal device sends a first message authentication code to the network authentication server.

Specifically, the terminal device receives the second random number, the second transmission parameter, and the second message authentication code that are sent by the network authentication server; performs the DH key agreement algorithm based on the first transmission parameter and the second transmission parameter to obtain the third transmission parameter; after the second message authentication code has been authenticated, generates the communication key of the terminal device based on the third transmission parameter and at least one of the first random number, the second random number, and the second parameter set by using the key derivation function; generates the first message authentication code based on the first random number, the second random number, the second parameter set, and either of the communication key and the second-level key by using a message authentication code generation function; and sends the first message authentication code to the network authentication server.

S404. The network authentication server receives the first message authentication code sent by the terminal device, and sends the communication key to a functional network element after the network authentication server has authenticated the first message authentication code.

Optionally, in the mutual authentication process, the first random number and the second random number may be encrypted for transmission. Optionally, in the mutual authentication process, at least one of the first transmission parameter and the second transmission parameter may be encrypted.

Optionally, when there are a plurality of preset DH protocols and groups, the authentication request message in step 401 further includes a DH protocol identifier and/or a DH group identifier of a preset DH protocol selected by the terminal device. The network authentication server determines a to-be-used DH protocol based on the received DH protocol identifier, and determines, based on the DH group identifier, a group such as a generator g of the preset DH protocol used during transmission parameter generation.

Compared with the first possible authentication implementation, in the second possible authentication implementation, the first transmission parameter and the second transmission parameter are added, to improve key agreement confidentiality in the authentication process.

Third Possible Authentication Implementation:

FIG. 5 is a signaling flowchart of Embodiment 3 of a key authentication method according to the present invention. As shown in FIG. 5, the method includes the following steps.

S501. The terminal device sends an authentication request message to the network authentication server.

Specifically, the terminal device determines a first random number; encrypts the first random number by using the second-level key, to obtain an encrypted first random number; generates a first message authentication code based on the second-level key and at least one of the second parameter set and the first random number by using a message authentication code generation function; and sends the authentication request message to the network authentication server, where the authentication request message includes the first message authentication code, the encrypted first random number, and the first parameter set.

S502. The network authentication server sends an encrypted second random number and a second message authentication code to the terminal device.

Specifically, the network authentication server decrypts the encrypted first random number based on the second-level key to obtain the first random number; determines a second random number, and encrypts the second random number by using the second-level key, to obtain the encrypted second random number; after the first message authentication code has been authenticated, generates the communication key of the network authentication server based on the second parameter set and at least one of the second-level key, the first random number, and the second random number by using the key derivation function; generates the second message authentication code based on either of the communication key and the second-level key and at least one of the first random number, the second random number, and the second parameter set; and sends the encrypted second random number and the second message authentication code to the terminal device, and sends the communication key to the functional network element.

S503. The terminal device generates the communication key.

Specifically, the terminal device receives the second message authentication code and the encrypted second random number that are sent by the network authentication server; decrypts the encrypted second random number based on the second-level key to obtain the second random number; and after the second message authentication code has been authenticated, generates the communication key of the terminal device based on the second parameter set and at least one of the second-level key, the first random number, and the second random number by using the key derivation function.

Optionally, the first random number and the second random number may not be encrypted in a process of generating the communication key based on the second-level key. Optionally, the communication key in step S502 may be obtained by the network authentication server based on a third random number. When the communication key is obtained based on the third random number, the network authentication server encrypts the communication key by using the second-level key, and sends an encrypted communication key to the terminal device, so that the terminal device can obtain the communication key after decrypting the encrypted communication key. Optionally, the first random number and the second random number may not be encrypted in a process of randomly generating the communication key.

Compared with the first and the second possible authentication implementations, in this authentication implementation, a quantity of times of signaling interaction is reduced, and authentication efficiency is improved.

Fourth Possible Authentication Implementation:

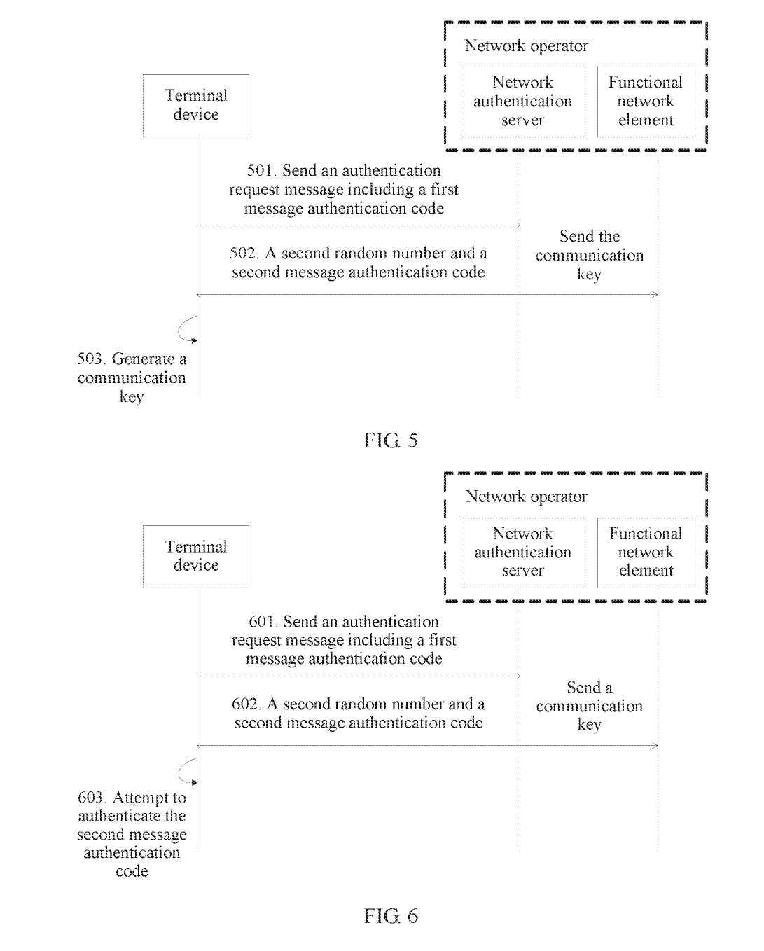

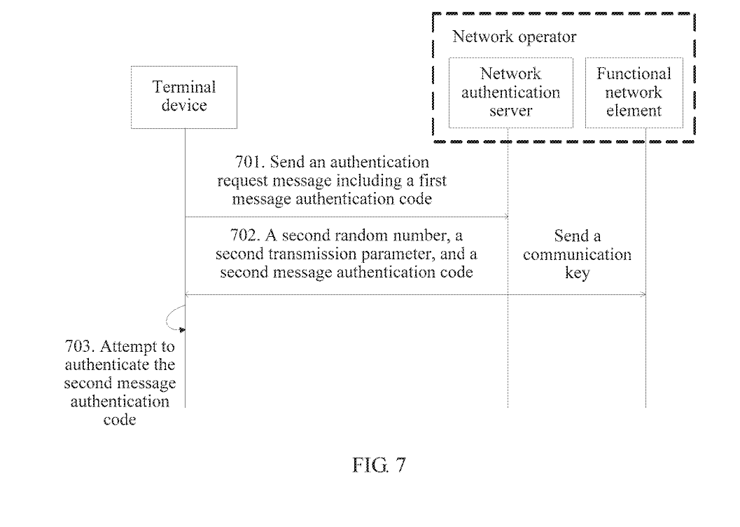

FIG. 6 is a signaling flowchart of Embodiment 4 of a key authentication method according to the present invention. As shown in FIG. 6, the method includes the following steps.

S601. The terminal device sends an authentication request message to the network authentication server.

Specifically, the terminal device determines a first random number; encrypts the first random number by using the second-level key, to obtain an encrypted first random number; generates the communication key of the terminal device based on the second parameter set and at least one of the second-level key and the first random number by using the key derivation function; generates a first message authentication code based on either of the second-level key and the communication key and at least one of the second parameter set and the first random number by using a message authentication code generation function; and sends the authentication request message to the network authentication server, where the authentication request message includes the first message authentication code, the encrypted first random number, and the first parameter set.

S602. The network authentication server sends an encrypted second random number and a second message authentication code to the terminal device.

Specifically, the network authentication server decrypts the encrypted first random number based on the second-level key to obtain the first random number; determines a second random number, and encrypts the second random number by using the second-level key, to obtain the encrypted second random number; after the network authentication server has authenticated the first message authentication code, generates the communication key of the terminal device based on the second parameter set and at least one of the second-level key and the first random number by using the key derivation function; generates the second message authentication code based on either of the communication key and the second-level key and at least one of the first random number, the second random number, and the second parameter set; and sends the encrypted second random number and the second message authentication code to the terminal device, and sends the communication key to the functional network element.

S603. The terminal device attempts to authenticate the second message authentication code.

Specifically, the terminal device receives the encrypted second random number and the second message authentication code that are sent by the network authentication server, decrypts the encrypted second random number based on the second-level key to obtain the second random number, and attempts to authenticate the second message authentication code and determines that the authentication succeeds.

Compared with the first and the second possible authentication implementations, in this authentication implementation, a quantity of times of signaling interaction is reduced, and authentication efficiency is improved.

Compared with the third possible authentication implementation, in this authentication implementation, the terminal device first generates the communication key based on the first random number, and does not rely on the second random number sent by the network authentication server. Optionally, the first random number and the second random number may not be encrypted in a process of generating the communication key based on the second-level key.

Fifth Possible Authentication Implementation:

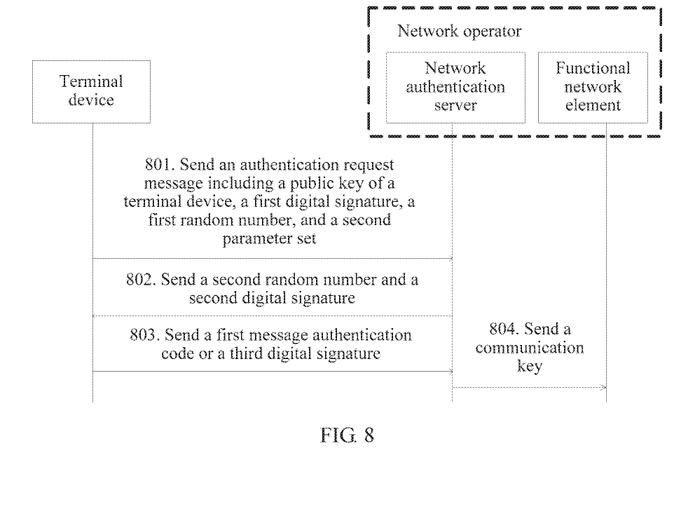

FIG. 7 is a signaling flowchart of Embodiment 5 of a key authentication method according to the present invention. As shown in FIG. 7, the method includes the following steps.

S701. The terminal device sends an authentication request message to the network authentication server.

Specifically, the terminal device determines a first random number and a first transmission parameter of a DH protocol; generates a first message authentication code based on the first key and the first random number by using a message authentication code generation function; and sends the authentication request message to the network authentication server, where the authentication request message includes the first message authentication code, the first random number, the first transmission parameter, and the device identifier of the terminal device.

S702. The network authentication server sends a second random number, a second transmission parameter, and a second message authentication code to the terminal device.

Specifically, the network authentication server determines the second random number and the second transmission parameter of the DH protocol; performs a DH key agreement algorithm based on the first transmission parameter and the second transmission parameter to obtain a third transmission parameter; after the network authentication server has authenticated the first message authentication code, generates the communication key of the network authentication server based on the third transmission parameter and at least one of the first random number, the second random number, and the second parameter set by using the key derivation function; generates the second message authentication code based on either of the communication key and the second-level key and any one of the first random number, the second random number, the first transmission parameter, the second transmission parameter, and the second parameter set; and sends the second random number and the second message authentication code to the terminal device, and sends the communication key to the functional network element.

S703. The terminal device attempts to authenticate the second message authentication code.

Specifically, the terminal device receives the second random number, the second transmission parameter, and the second message authentication code that are sent by the network authentication server; performs the DH key agreement algorithm based on the first transmission parameter and the second transmission parameter to obtain the third transmission parameter; generates the communication key of the terminal device based on the third transmission parameter and at least one of the first random number and the second random number by using the key derivation function; and attempts to authenticate the second message authentication code and determines that the authentication succeeds.

Compared with the first and the second possible authentication implementations, in this authentication implementation, a quantity of times of signaling interaction is reduced, and authentication efficiency is improved.

Optionally, in the mutual authentication process, the first random number, the second random number, the first transmission parameter, and the second transmission parameter may also be encrypted for transmission, so as to improve confidentiality.

Optionally, when there are a plurality of preset DH protocols and groups, the authentication request message in step 701 further includes a DH protocol identifier and/or a DH group identifier of a preset DH protocol selected by the terminal device. The network authentication server determines a to-be-used DH protocol based on the received DH protocol identifier, and determines, based on the DH group identifier, a group such as a generator g of the preset DH protocol used during transmission parameter generation.

Compared with the first possible authentication implementation, in this possible authentication implementation, the first transmission parameter and the second transmission parameter are added, to improve confidentiality in the authentication process.

An authentication manner based on the identity key technology includes the following possible implementations.

Sixth Possible Authentication Implementation:

FIG. 8 is a signaling flowchart of Embodiment 6 of a key authentication method according to the present invention. As shown in FIG. 8, the method includes the following steps.

S801. The terminal device sends an authentication request message to the network authentication server, where the authentication request message includes a public key of the terminal device, a first digital signature, a first random number, and a second parameter set.

Specifically, the terminal device determines the first random number, encrypts the first random number by using the public key of the network authentication server, to obtain an encrypted first random number, and sends the authentication request message to the network authentication server, where the authentication request message includes the public key of the terminal device, the first digital signature, the encrypted first random number, and the second parameter set.

S802. The network authentication server sends an encrypted second random number and a second digital signature to the terminal device.

Specifically, the network authentication server decrypts the encrypted first random number based on the private key of the network authentication server to obtain the first random number; determines a second random number, and encrypts the second random number by using the public key of the terminal device, to obtain the encrypted second random number; after the first digital signature has been authenticated, generates the communication key of the network authentication server based on the second parameter set and at least one of the first random number and the second random number by using the key derivation function; generates the second digital signature based on the private key of the network authentication server, the first random number, the second random number, and the second parameter set; and sends the second digital signature and the encrypted second random number to the terminal device.

S803. The terminal device sends a first message authentication code or a third digital signature to the network authentication server.

Specifically, the terminal device receives the encrypted second random number and the second digital signature that are sent by the network authentication server; decrypts the encrypted second random number based on the second-level key of the terminal device to obtain the second random number; after the second digital signature has been authenticated, generates the communication key of the terminal device based on the second parameter set and at least one of the first random number and the second random number by using the key derivation function; generates the first message authentication code based on the communication key, the first random number, the second random number, and the second parameter set, or generates the third digital signature based on the second-level key, the first random number, the second random number, and the second parameter set; and sends the first message authentication code or the third digital signature to the network authentication server.

S804. The network authentication server receives the first message authentication code or the third digital signature sent by the terminal device, and sends the communication key to a functional network element after the network authentication server has authenticated the first message authentication code or the third digital signature.

The terminal device receives the public key of the terminal device, the first digital signature, and the second parameter set that are sent by the user management server.

Specifically, in the foregoing authentication process, the first digital signature, the second digital signature, and the third digital signature may be encrypted, so as to improve confidentiality of the authentication process.

Optionally, the communication key in step S802 may be obtained by the network authentication server based on a third random number. When the communication key is obtained based on the third random number, the network authentication server encrypts the communication key by using the public key of the terminal device, and sends an encrypted communication key to the terminal device, so that the terminal device can obtain the communication key after decrypting the encrypted communication key based on the private key of the terminal device, namely the second-level key. Optionally, the first random number and the second random number may not be encrypted in a process of randomly generating the communication key.

Seventh Possible Authentication Implementation:

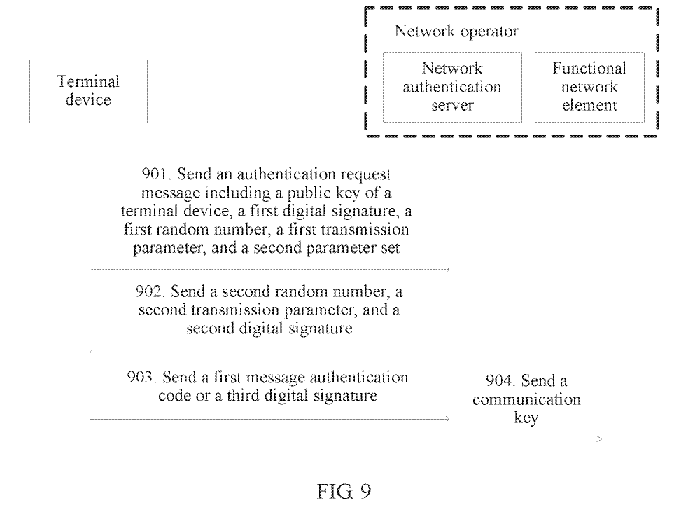

FIG. 9 is a signaling flowchart of Embodiment 7 of a key authentication method according to the present invention. As shown in FIG. 9, the method includes the following steps.

S901. The terminal device sends an authentication request message to the network authentication server, where the authentication request message includes a public key of the terminal device, a first digital signature, a first random number, a first transmission parameter, and a second parameter set.

Specifically, the terminal device determines the first random number and the first transmission parameter of a DH protocol, and sends the authentication request message to the network authentication server, where the authentication request message includes the public key of the terminal device, the first digital signature, the first random number, the first transmission parameter, and the second parameter set.

S902. The network authentication server sends a second random number, a second transmission parameter, and a second digital signature to the terminal device.

Specifically, the network authentication server determines the second random number and the second transmission parameter of the DH protocol; performs a DH key agreement algorithm based on the first transmission parameter and the second transmission parameter to obtain a third transmission parameter; after the first digital signature has been authenticated, generates the communication key of the network authentication server based on the third transmission parameter and at least one of the first random number, the second random number, and the second parameter set by using the key derivation function; generates the second digital signature based on the private key of the network authentication server, the first transmission parameter, the second transmission parameter, and at least one of the first random number, the second random number, and the second parameter set; and sends the second random number, the second transmission parameter, and the second digital signature to the terminal device.

S903. The terminal device sends a first message authentication code or a third digital signature to the network authentication server.

Specifically, the terminal device receives the second transmission parameter, the second random number, and the second digital signature that are sent by the network authentication server; performs the DH key agreement algorithm based on the first transmission parameter and the second transmission parameter to obtain the third transmission parameter; after the second digital signature has been authenticated, generates the communication key of the terminal device based on the third transmission parameter and at least one of the first random number, the second random number, and the second parameter set by using the key derivation function; generates the first message authentication code based on the communication key, the first transmission parameter, the second transmission parameter, and at least one of the first random number, the second random number, and the second parameter set by using a message authentication code generation function, or generates the third digital signature based on the second-level key, the first transmission parameter, the second transmission parameter, and at least one of the first random number, the second random number, and the second parameter set; and sends the first message authentication code or the third digital signature to the network authentication server.

S904. The network authentication server receives the first message authentication code or the third digital signature sent by the terminal device, and sends the communication key to a functional network element after the network authentication server has authenticated the first message authentication code or the third digital signature.

Eighth Possible Authentication Implementation:

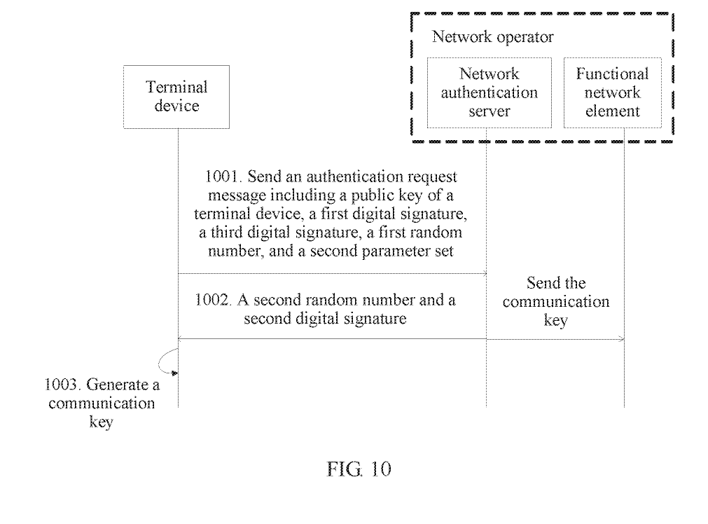

FIG. 10 is a signaling flowchart of Embodiment 8 of a key authentication method according to the present invention. As shown in FIG. 10, the method includes the following steps.

S1001. The terminal device sends an authentication request message to the network authentication server, where the authentication request message includes a public key of the terminal device, a first digital signature, a third digital signature, a first random number, and a second parameter set.

Specifically, the terminal device determines the first random number, and encrypts the first random number by using the public key of the network authentication server, to obtain an encrypted first random number; generates the third digital signature based on the second-level key, the first random number, and the second parameter set; and sends the authentication request message to the network authentication server, where the authentication request message includes the public key of the terminal device, the first digital signature, the third digital signature, the encrypted first random number, and the second parameter set.

S1002. The network authentication server sends an encrypted second random number and a second digital signature to the terminal device.

Specifically, the network authentication server decrypts the encrypted first random number based on the private key of the network authentication server to obtain the first random number; determines a second random number, and encrypts the second random number by using the public key of the terminal device, to obtain the encrypted second random number; after the first digital signature and the third digital signature have been authenticated, generates the communication key of the network authentication server based on the second parameter set and at least one of the first random number and the second random number by using the key derivation function; generates the second digital signature based on the private key of the network authentication server, the first random number, the second random number, and the second parameter set; and sends the second digital signature and the encrypted second random number to the terminal device, and sends the communication key to the functional network element.

S1003. The terminal device generates the communication key.

Specifically, the terminal device receives the second digital signature and the encrypted second random number that are sent by the network authentication server; decrypts the encrypted second random number based on the second-level key of the terminal device to obtain the second random number; and after the second digital signature has been authenticated, generates the communication key of the terminal device based on the second parameter set and at least one of the first random number and the second random number by using the key derivation function.

Optionally, the communication key in step S1002 may be obtained by the network authentication server based on a third random number. When the communication key is obtained based on the third random number, the network authentication server encrypts the communication key by using the public key of the terminal device, and sends an encrypted communication key to the terminal device, so that the terminal device can obtain the communication key after decrypting the encrypted communication key based on the private key of the terminal device, namely the second-level key. Optionally, the first random number and the second random number may not be encrypted in a process of randomly generating the communication key.

Compared with the sixth and the seventh possible authentication implementations, in this authentication implementation, a quantity of times of signaling interaction is reduced, and authentication efficiency is improved.

An authentication manner based on the hierarchical identity key technology includes the following possible implementations:

Ninth Possible Authentication Implementation:

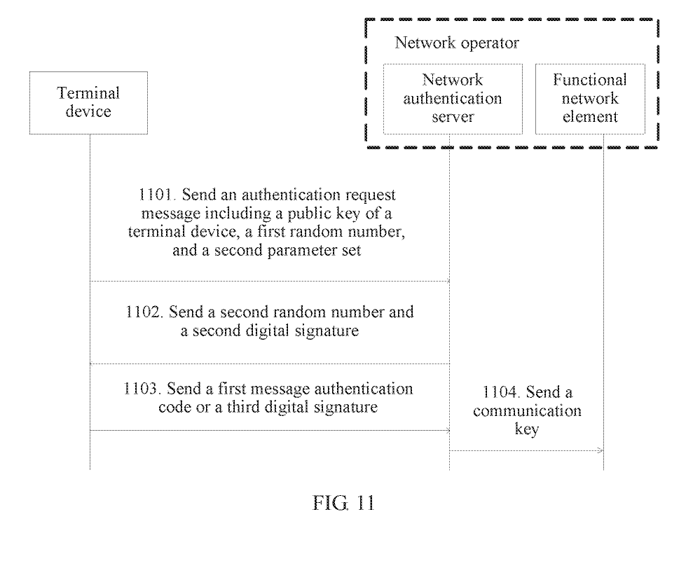

FIG. 11 is a signaling flowchart of Embodiment 9 of a key authentication method according to the present invention. As shown in FIG. 11, the method includes the following steps.

S1101. The terminal device sends an authentication request message to the network authentication server, where the authentication request message includes a public key of the terminal device, a first random number, and a second parameter set.

Specifically, the terminal device determines the first random number, encrypts the first random number by using the public key of the network authentication server, to obtain an encrypted first random number, and sends the authentication request message to the network authentication server, where the authentication request message includes the public key of the terminal device, the encrypted first random number, and the second parameter set.

S1102. The network authentication server sends an encrypted second random number and a second digital signature to the terminal device.

Specifically, the network authentication server decrypts the encrypted first random number based on the private key of the network authentication server to obtain the first random number; determines a second random number, and encrypts the second random number by using the public key of the terminal device, to obtain the encrypted second random number; generates the communication key of the network authentication server based on the second parameter set and at least one of the first random number and the second random number by using the key derivation function; generates the second digital signature based on the private key of the network authentication server, the first random number, the second random number, and the second parameter set; and sends the encrypted second random number and the second digital signature to the terminal device.

S1103. The terminal device sends a first message authentication code or a third digital signature to the network authentication server.

Specifically, the terminal device receives the encrypted second random number and the second digital signature that are sent by the network authentication server; decrypts the encrypted second random number based on the second-level key of the terminal device to obtain the second random number; after the second digital signature has been authenticated, generates the communication key of the terminal device based on the second parameter set and at least one of the first random number and the second random number by using the key derivation function, generates the first message authentication code based on the communication key, the first random number, the second random number, and the second parameter set, or generates the third digital signature based on the second-level key, the first random number, the second random number, and the second parameter set; and sends the first message authentication code or the third digital signature to the network authentication server.

S1104. The network authentication server receives the first message authentication code or the third digital signature sent by the terminal device, and sends the communication key to a functional network element after the network authentication server has authenticated the first message authentication code or the third digital signature.

Optionally, the communication key in step S1102 may be obtained by the network authentication server based on a third random number. When the communication key is obtained based on the third random number, the network authentication server encrypts the communication key by using the public key of the terminal device, and sends an encrypted communication key to the terminal device, so that the terminal device can obtain the communication key after decrypting the encrypted communication key based on the private key of the terminal device, namely the second-level key. Optionally, the first random number and the second random number may not be encrypted in a process of randomly generating the communication key.

Tenth Possible Authentication Implementation:

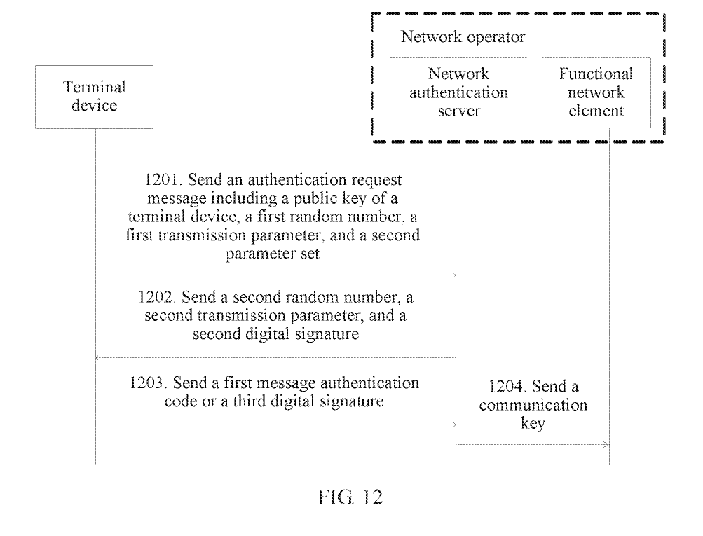

FIG. 12 is a signaling flowchart of Embodiment 10 of a key authentication method according to the present invention. As shown in FIG. 12, the method includes the following steps.

S1201. The terminal device sends an authentication request message to the network authentication server, where the authentication request message includes a public key of the terminal device, a first random number, a first transmission parameter, and a second parameter set.

Specifically, the terminal device determines the first random number and the first transmission parameter of a DH protocol, and sends the authentication request message to the network authentication server, where the authentication request message includes the public key of the terminal device, the first random number, the first transmission parameter, and the second parameter set.

S1202. The network authentication server sends a second random number, a second transmission parameter, and a second digital signature to the terminal device.

Specifically, the network authentication server determines the second random number and the second transmission parameter of the DH protocol; performs a DH key agreement algorithm based on the first transmission parameter and the second transmission parameter to obtain a third transmission parameter; generates the communication key of the network authentication server based on the third transmission parameter and at least one of the first random number, the second random number, and the second parameter set by using the key derivation function; generates the second digital signature based on the private key of the network authentication server, the first transmission parameter, the second transmission parameter, and at least one of the first random number, the second random number, and the second parameter set; and sends the second random number, the second transmission parameter, and the second digital signature to the terminal device.

S1203. The terminal device sends a first message authentication code or a third digital signature to the network authentication server.

Specifically, the terminal device receives the second transmission parameter, the second random number, and the second digital signature that are sent by the network authentication server; performs the DH key agreement algorithm based on the first transmission parameter and the second transmission parameter to obtain the third transmission parameter; after the second digital signature has been authenticated, generates the communication key of the terminal device based on the third transmission parameter and at least one of the first random number, the second random number, and the second parameter set by using the key derivation function; generates the first message authentication code based on the communication key, the first transmission parameter, the second transmission parameter, and at least one of the first random number, the second random number, and the second parameter set by using a message authentication code generation function, or generates the third digital signature based on the second-level key, the first transmission parameter, the second transmission parameter, and at least one of the first random number, the second random number, and the second parameter set; and sends the first message authentication code or the third digital signature to the network authentication server.

S1204. The network authentication server receives the first message authentication code or the third digital signature sent by the terminal device, and sends the communication key to a functional network element after the network authentication server has authenticated the first message authentication code or the third digital signature.

Eleventh Possible Authentication Implementation:

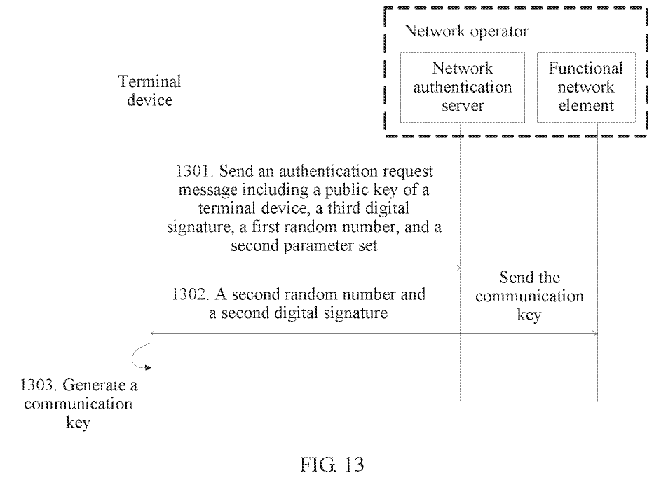

FIG. 13 is a signaling flowchart of Embodiment 11 of a key authentication method according to the present invention. As shown in FIG. 13, the method includes the following steps.

S1301. The terminal device sends an authentication request message to the network authentication server, where the authentication request message includes a public key of the terminal device, a third digital signature, a first random number, and a second parameter set.

Specifically, the terminal device determines the first random number, and encrypts the first random number by using the public key of the network authentication server, to obtain an encrypted first random number; generates the third digital signature based on the second-level key, the first random number, and the second parameter set; and sends the authentication request message to the network authentication server, where the authentication request message includes the public key of the terminal device, the third digital signature, the encrypted first random number, and the second parameter set.

S1302. The network authentication server sends an encrypted second random number and a second digital signature to the terminal device.

Specifically, the network authentication server decrypts the encrypted first random number based on the private key of the network authentication server to obtain the first random number; determines a second random number, and encrypts the second random number by using the public key of the terminal device, to obtain the encrypted second random number; after the third digital signature has been authenticated, generates the communication key of the network authentication server based on the second parameter set and at least one of the first random number and the second random number by using the key derivation function; generates the second digital signature based on the private key of the network authentication server, the first random number, the second random number, and the second parameter set; and sends the second digital signature and the encrypted second random number to the terminal device, and sends the communication key to the functional network element.

S1303. The terminal device generates the communication key.

Specifically, the terminal device receives the second digital signature and the encrypted second random number that are sent by the network authentication server; decrypts the encrypted second random number based on the second-level key of the terminal device to obtain the second random number; and after the second digital signature has been authenticated, generates the communication key of the terminal device based on the second parameter set and at least one of the first random number and the second random number by using the key derivation function.

Optionally, the communication key in step S1302 may be obtained by the network authentication server based on a third random number. When the communication key is obtained based on the third random number, the network authentication server encrypts the communication key by using the public key of the terminal device, and sends an encrypted communication key to the terminal device, so that the terminal device can obtain the communication key after decrypting the encrypted communication key based on the private key of the terminal device, namely the second-level key. Optionally, the first random number and the second random number may not be encrypted in a process of randomly generating the communication key. Optionally, if the communication key is generated by using only the first random number, the terminal device may perform, in step S1301, the action in step S1303 of generating the communication key.

Compared with the ninth and the tenth possible authentication implementations, in this authentication implementation, a quantity of times of signaling interaction is reduced, and authentication efficiency is improved.

In an authentication manner based on a privacy-enhancing identity key technology, the public key of the user management server is a public key of the terminal device that is corresponding to the second-level key of the terminal device. The authentication manner includes the following possible implementations.

Twelfth Possible Authentication Implementation:

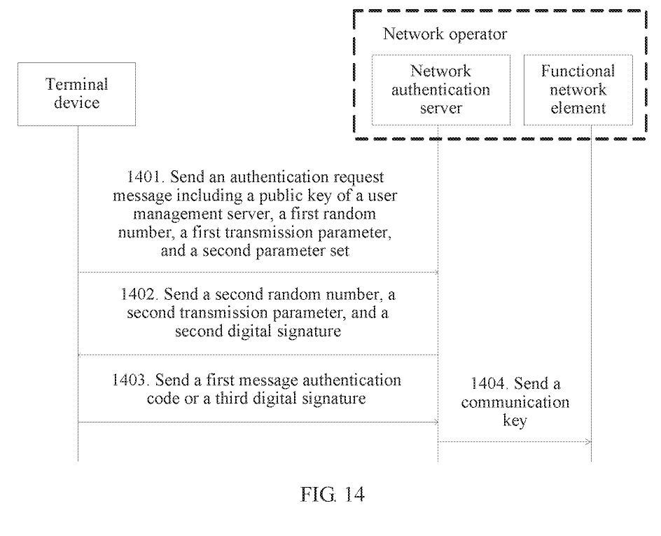

FIG. 14 is a signaling flowchart of Embodiment 12 of a key authentication method according to the present invention. As shown in FIG. 14, the method includes the following steps.

S1401. The terminal device sends an authentication request message to the network authentication server, where the authentication request message includes a public key of the user management server, a first random number, a first transmission parameter, and a second parameter set.

Specifically, the terminal device determines the first random number and the first transmission parameter of a DH protocol, and sends the authentication request message to the network authentication server, where the authentication request message includes the public key of the user management server, the first random number, the first transmission parameter, and the second parameter set.

S1402. The network authentication server sends a second random number, a second transmission parameter, and a second digital signature to the terminal device.

Specifically, the network authentication server determines the second random number and the second transmission parameter of the DH protocol; performs a DH key agreement algorithm based on the first transmission parameter and the second transmission parameter to obtain a third transmission parameter; generates the communication key of the network authentication server based on the third transmission parameter and at least one of the first random number, the second random number, and the second parameter set by using the key derivation function; generates the second digital signature based on the private key of the network authentication server, the first transmission parameter, the second transmission parameter, and at least one of the first random number, the second random number, and the second parameter set; and sends the second random number, the second transmission parameter, and the second digital signature to the terminal device.

S1403. The terminal device sends a first message authentication code or a third digital signature to the network authentication server.

Specifically, the terminal device receives the second transmission parameter, the second random number, and the second digital signature that are sent by the network authentication server; performs the DH key agreement algorithm based on the first transmission parameter and the second transmission parameter to obtain the third transmission parameter; after the second digital signature has been authenticated, generates the communication key of the terminal device based on the third transmission parameter and at least one of the first random number, the second random number, and the second parameter set by using the key derivation function; generates the first message authentication code based on the communication key, the first transmission parameter, the second transmission parameter, and at least one of the first random number, the second random number, and the second parameter set by using a message authentication code generation function, or generates the third digital signature based on the second-level key, the first transmission parameter, the second transmission parameter, and at least one of the first random number, the second random number, and the second parameter set; and sends the first message authentication code or the third digital signature to the network authentication server.

S1404. The network authentication server receives the first message authentication code or the third digital signature sent by the terminal device, and sends the communication key to a functional network element after the network authentication server has authenticated the first message authentication code or the third digital signature.

Thirteenth Possible Authentication Implementation:

FIG. 15 is a signaling flowchart of Embodiment 13 of a key authentication method according to the present invention. As shown in FIG. 15, the method includes the following steps.

S1501. The terminal device sends an authentication request message to the network authentication server, where the authentication request message includes a public key of the user management server, a third digital signature, a first random number, a first transmission parameter, and a second parameter set.

Specifically, the terminal device determines the first random number and the first transmission parameter of a DH protocol, generates the third digital signature based on the second-level key, the first transmission parameter, and at least one of the first random number and the second parameter set, and sends the authentication request message to the network authentication server, where the authentication request message includes the public key of the user management server, the third digital key, the first random number, the first transmission parameter, and the second parameter set.

S1502. The network authentication server sends a second random number and a second digital signature to the terminal device.

Specifically, the network authentication server determines the second random number and the second transmission parameter of the DH protocol, performs a DH key agreement algorithm based on the first transmission parameter and the second transmission parameter to obtain a third transmission parameter; after the third digital signature has been authenticated, generates the communication key of the network authentication server based on the third transmission parameter and at least one of the first random number, the second random number, and the second parameter set by using the key derivation function; generates the second digital signature based on the private key of the network authentication server, the first transmission parameter, the second transmission parameter, and at least one of the first random number, the second random number, and the second parameter set; and sends the second random number, the second transmission parameter, and the second digital signature to the terminal device, and sends the communication key to the functional network element.

S1503. The terminal device generates the communication key.

Specifically, the terminal device receives the second transmission parameter, the second random number, and the second digital signature that are sent by the network authentication server; performs the DH key agreement algorithm based on the first transmission parameter and the second transmission parameter to obtain the third transmission parameter; and after the second digital signature has been authenticated, generates the communication key of the terminal device based on the third transmission parameter and at least one of the first random number, the second random number, and the second parameter set by using the key derivation function.

Optionally, in step 1502, the network authentication server may further generate a message authentication code based on the communication key after generating the communication key, and send the message authentication code to the terminal device. The terminal device may first generate the communication key, and then attempt to authenticate the received message authentication code. Optionally, if the communication key is generated by using only the first random number, the terminal device may perform, in step S1501, the action in step S1503 of generating the communication key.

Compared with the twelfth possible authentication implementation, in this authentication implementation, a quantity of times of signaling interaction is reduced, and authentication efficiency is improved.

Optionally, in the seventh, the tenth, the twelfth, and the thirteenth possible authentication implementations, when there are a plurality of preset DH protocols and groups, the authentication request message further includes a DH protocol identifier and/or a DH group identifier of a preset DH protocol selected by the terminal device. The network authentication server determines a to-be-used DH protocol based on the received DH protocol identifier, and determines, based on the DH group identifier, a group such as a generator g of the preset DH protocol used during transmission parameter generation.

In the foregoing authentication manner based on the asymmetric key technology, the network authentication server further receives a public key request message sent by the terminal device, and sends the public key of the network authentication server to the terminal device.

Another aspect of the embodiments of the present invention provides a service center server to execute the key distribution method in the foregoing embodiment. The service center server has the same technical features and technical effects as the key distribution method in the foregoing embodiment.

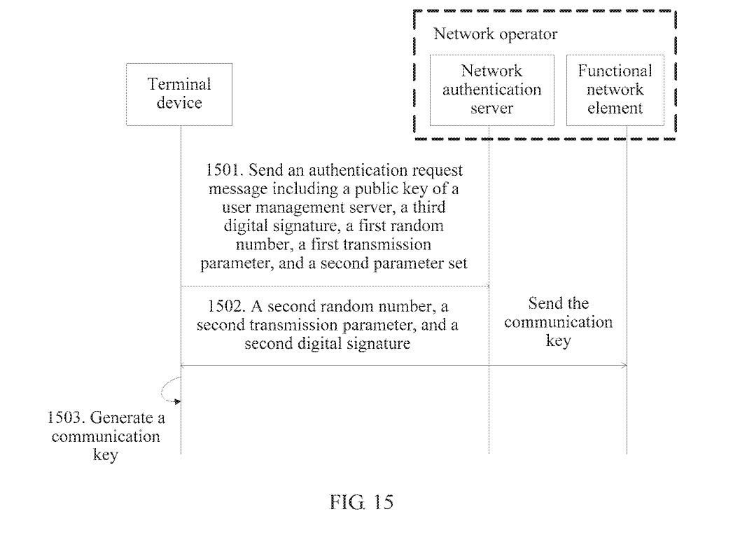

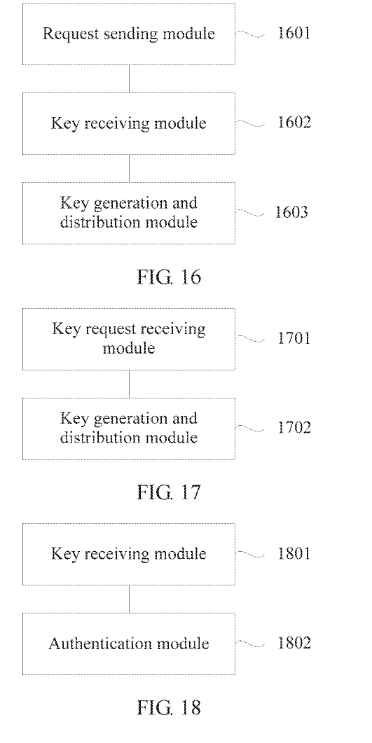

FIG. 16 is a schematic structural diagram of Embodiment 1 of a user management server according to the present invention. As shown in FIG. 16, the server includes:

a request sending module 1601, configured to send a first key request message to a service center server, where the first key request message is used to instruct the service center server to generate a first-level key of the user management server, and the first key request message includes a user identifier of the user management server;

a key receiving module 1602, configured to receive the first-level key of the user management server that is sent by the service center server; and

a key generation and distribution module 1603, configured to: generate a second-level key of a terminal device based on the first-level key, and send the second-level key to the terminal device, so that the terminal device performs mutual authentication with a network authentication server based on the second-level key, to obtain a communication key for communication between the terminal device and a functional network element.

Optionally, on the basis of the embodiment shown in FIG. 16, the key generation and distribution module 1603 is specifically configured to:

generate the second-level key of the terminal device based on the first-level key and a first parameter set by using a key derivation function; and send the second-level key and the first parameter set to the terminal device, so that the terminal device performs mutual authentication with the network authentication server based on the second-level key, to obtain the communication key for communication between the terminal device and the functional network element; where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key.

Optionally, on the basis of the embodiment shown in FIG. 16, the first-level key is a private key of the user management server, and the key generation and distribution module 1603 is specifically configured to:

generate the second-level key of the terminal device and a public key of the terminal device based on the private key of the user management server and a first parameter set, where the second-level key is a private key of the terminal device that is corresponding to the public key of the terminal device;

generate a first digital signature based on the first-level key, the public key of the terminal device, and the first parameter set; and

send the public key of the terminal device, the second-level key, the first digital signature, and a second parameter set to the terminal device, so that the terminal device performs mutual authentication with the network authentication server based on the second-level key, to obtain the communication key for communication between the terminal device and the functional network element; where

the first parameter set includes at least one of the user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

Optionally, on the basis of the embodiment shown in FIG. 16, the first-level key is a private key of the user management server, and the key generation and distribution module 1603 is specifically configured to:

generate the second-level key of the terminal device based on the private key of the user management server and a device identifier of the terminal device by using a device identity-based generation algorithm, where the second-level key is a private key of the terminal device; and

send, to the terminal device, a second parameter set, the second-level key, and a public key of the terminal device that is corresponding to the private key of the terminal device, so that the terminal device performs mutual authentication with the network authentication server based on the second-level key, to obtain the communication key for communication between the terminal device and the functional network element; where

the second parameter set includes at least one of the user identifier of the user management server, the device identifier of the terminal device, a network identifier of the user management server, and a service parameter.

Optionally, on the basis of the embodiment shown in FIG. 16, the first-level key is a private key of the user management server, the key receiving module is further configured to receive a public key of the user management server that is sent by the service center server, and the key generation and distribution module 1603 is specifically configured to:

generate the second-level key of the terminal device based on the private key of the user management server by using a privacy-enhancing technologies-based key generation algorithm, where the second-level key is a private key of the terminal device; and

send the public key of the user management server, the second-level key, and a second parameter set to the terminal device, so that the terminal device performs mutual authentication with the network authentication server based on the second-level key, to obtain the communication key for communication between the terminal device and the functional network element; where

the second parameter set includes at least one of the user identifier of the user management server, a device identifier of the terminal device, a network identifier of the user management server, and a service parameter.

Still another aspect of the embodiments of the present invention provides a service center server to execute the key distribution method in the foregoing embodiment. The service center server has the same technical features and technical effects as the key distribution method in the foregoing embodiment.

FIG. 17 is a schematic structural diagram of Embodiment 1 of the service center server according to the present invention. As shown in FIG. 17, the server includes:

a key request receiving module 1701, configured to receive a first key request message sent by a user management server, where the first key request message is used to instruct the service center server to generate a first-level key of the user management server, and the first key request message includes a user identifier of the user management server; and

a key generation and distribution module 1702, configured to: generate, based on the first key request message, the first-level key of the user management server corresponding to the user identifier, and send the first-level key to the user management server.

Optionally, on the basis of the embodiment shown in FIG. 17, the key generation and distribution module 1702 is specifically configured to:

generate the first-level key of the user management server based on a third parameter set by using a key derivation function, and send the first-level key to the user management server; where

the third parameter set includes at least one of a key random number of the first-level key, a fresh parameter of the first-level key, a time parameter of the first-level key, and a shared key, and the shared key is a key shared by the user management server and the service center server;

or

determine a service random number, use the service random number as the first-level key of the user management server, and send the first-level key to the user management server.

Optionally, on the basis of the embodiment shown in FIG. 17, the first key request message further includes at least one of a network identifier of the user management server and a service parameter, and the key generation and distribution module 1702 is specifically configured to:

generate the first-level key of the user management server based on a fourth parameter set by using a key derivation function, and send the first-level key to the user management server; where

the fourth parameter set includes at least one of the user identifier of the user management server, the network identifier of the user management server, the service parameter, a key random number of the first-level key, a fresh parameter of the first-level key, a time parameter of the first-level key, and a shared key, and the shared key is a key shared by the user management server and the service center server.

Optionally, on the basis of the embodiment shown in FIG. 17, the key generation and distribution module 1702 is specifically configured to:

generate the first-level key of the user management server based on the user identifier of the user management server by using a key generation algorithm in identity-based cryptography, and send the first-level key to the user management server, where the first-level key is a private key of the user management server.

Optionally, on the basis of the embodiment shown in FIG. 17, the key generation and distribution module 1702 is specifically configured to:

generate the first-level key of the user management server based on the user identifier of the user management server and a fifth parameter set by using a key generation algorithm in identity-based cryptography, and send the first-level key to the user management server, where the first-level key is a private key of the user management server, where

the fifth parameter set includes at least one of the following:

a key random number of the first-level key, a fresh parameter of the first-level key, and a time parameter of the first-level key.

Optionally, on the basis of the embodiment shown in FIG. 17, the key generation and distribution module 1702 is specifically configured to:

generate a private key of the user management server and a public key of the user management server by using privacy-enhancing technologies, where the private key of the user management server is the first-level key of the user management server; and send the first-level key and the public key of the user management server to the user management server.

Optionally, on the basis of the embodiment shown in FIG. 17, when a mutual authentication process is based on a symmetric key technology, the key request receiving module 1701 is further configured to receive a second key request message sent by the network authentication server, where the second key request message includes the user identifier of the user management server; and

the key generation and distribution module 1702 is further configured to: retrieve or generate the first-level key based on the user identifier of the user management server in the second key request message, and send the first-level key to the network authentication server, so that the network authentication server generates a second-level key of a terminal device based on the first-level key, and performs mutual authentication with the terminal device based on the second-level key.

Optionally, on the basis of the embodiment shown in FIG. 17, when a mutual authentication process is based on a symmetric key technology, the key request receiving module 1701 is further configured to receive a second key request message sent by the network authentication server, where the second key request message includes a first parameter set; and

the key generation and distribution module 1702 is further configured to: generate a second-level key of a terminal device based on the first-level key and the first parameter set by using the key derivation function, and send the second-level key to the network authentication server, so that the network authentication server performs mutual authentication with the terminal device based on the second-level key; where

the first parameter set includes at least one of the user identifier of the user management server, a device identifier of the terminal device, a network identifier of the user management server, the service parameter, a key random number of the second-level key, a fresh parameter of the second-level key, and a time parameter of the second-level key.

Still another aspect of the embodiments of the present invention provides a terminal device to execute the key authentication method in the foregoing embodiment. The terminal device has the same technical features and technical effects as the key authentication method in the foregoing embodiment.

FIG. 18 is a schematic structural diagram of Embodiment 1 of the terminal device according to the present invention. As shown in FIG. 18, the terminal device includes:

a key receiving module 1801, configured to receive a second-level key of the terminal device that is sent by a user management server; and

an authentication module 1802, configured to perform mutual authentication with a network authentication server based on the second-level key, to obtain a communication key for communication between the terminal device and a functional network element.

The following describes in detail the mutual authentication process performed by the authentication module 1802 by using specific embodiments. As described in the foregoing method embodiment, mutual authentication manners include at least an authentication manner based on a symmetric key technology and an authentication manner based on an identity key technology.

The authentication manner based on the symmetric key technology includes the following possible implementations.

In a first feasible authentication manner, the key receiving module 1801 is further configured to receive a first parameter set sent by the user management server; and the authentication module 1802 is specifically configured to:

determine a first random number, encrypt the first random number by using the second-level key, to obtain an encrypted first random number, and send an authentication request message to the network authentication server, where the authentication request message includes the first parameter set and the encrypted first random number;

receive an encrypted second random number and a second message authentication code that are sent by the network authentication server, and decrypt the encrypted second random number based on the second-level key to obtain a second random number, where the encrypted second random number is obtained after the network authentication server encrypts the second random number by using the second-level key; and

after the second message authentication code has been authenticated, generate the communication key of the terminal device based on a second parameter set and at least one of the second-level key, the first random number, and the second random number by using a key derivation function; generate a first message authentication code based on the first random number, the second random number, the second parameter set, and either of the communication key and the second-level key, and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a second feasible authentication manner, the key receiving module 1801 is further configured to receive a first parameter set sent by the user management server; and the authentication module 1802 is specifically configured to:

determine a first random number, and send an authentication request message to the network authentication server, where the authentication request message includes the first parameter set and the first random number;

receive a second random number and a second message authentication code that are sent by the network authentication server; and

after the second message authentication code has been authenticated, generate the communication key of the terminal device based on the second-level key and at least one of the first random number, the second random number, and a second parameter set by using a key derivation function; generate a first message authentication code based on the first random number, the second random number, the second parameter set, and either of the communication key and the second-level key; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a third feasible authentication manner, the key receiving module 1801 is further configured to receive a first parameter set sent by the user management server; and the authentication module 1802 is specifically configured to:

determine a first random number, and send an authentication request message to the network authentication server, where the authentication request message includes the first parameter set and the first random number;

receive a second random number, a second message authentication code, and an encrypted communication key that are sent by the network authentication server, and decrypt the encrypted communication key based on the second-level key to obtain the communication key, where the encrypted communication key is obtained after the network authentication server encrypts the communication key by using the second-level key; and

after the second message authentication code has been authenticated, generate a first message authentication code based on the first random number, the second random number, the second parameter set, and either of the communication key and the second-level key; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a fourth feasible authentication manner, the key receiving module 1801 is further configured to receive a first parameter set sent by the user management server; and the authentication module 1802 is specifically configured to:

determine a first random number and a first transmission parameter of a DH protocol, and send an authentication request message to the network authentication server, where the authentication request message includes the first random number, the first transmission parameter, and the first parameter set;

receive a second transmission parameter, a second random number, and a second message authentication code that are sent by the network authentication server, and perform a DH key agreement algorithm based on the first transmission parameter and the second transmission parameter to obtain a third transmission parameter; and

after the second message authentication code has been authenticated, generate the communication key of the terminal device based on the third transmission parameter and at least one of the first random number, the second random number, and a second parameter set by using a key derivation function; generate a first message authentication code based on the first random number, the second random number, the second parameter set, and either of the communication key and the second-level key by using a message authentication code generation function; and send the first message authentication code to the network authentication server, so that the network authentication server attempts to authenticate the first message authentication code; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a fifth feasible authentication manner, the key receiving module 1801 is further configured to receive a first parameter set sent by the user management server; and the authentication module 1802 is specifically configured to:

determine a first random number; encrypt the first random number by using the second-level key, to obtain an encrypted first random number; generate a first message authentication code based on the second-level key and at least one of a second parameter set and the first random number by using a message authentication code generation function; and send an authentication request message to the network authentication server, where the authentication request message includes the first message authentication code, the encrypted first random number, and the first parameter set;

receive a second message authentication code and an encrypted second random number that are sent by the network authentication server, and decrypt the encrypted second random number based on the second-level key to obtain a second random number, where the encrypted second random number is obtained after the network authentication server encrypts the second random number by using the second-level key; and

after the second message authentication code has been authenticated, generate the communication key of the terminal device based on the second parameter set and at least one of the second-level key, the first random number, and the second random number by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a sixth feasible authentication manner, the key receiving module 1801 is further configured to receive a first parameter set sent by the user management server; and the authentication module 1802 is specifically configured to:

determine a first random number; generate a first message authentication code based on the second-level key and at least one of a second parameter set and the first random number by using a message authentication code generation function; and send an authentication request message to the network authentication server, where the authentication request message includes the first message authentication code, the first random number, and the first parameter set;

receive a second random number and a second message authentication code that are sent by the network authentication server; and

after the second message authentication code has been authenticated, generate the communication key of the terminal device based on the second-level key and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a seventh feasible authentication manner, the key receiving module 1801 is further configured to receive a first parameter set sent by the user management server; and the authentication module 1802 is specifically configured to:

determine a first random number; generate a first message authentication code based on the second-level key and at least one of a second parameter set and the first random number by using a message authentication code generation function; and send an authentication request message to the network authentication server, where the authentication request message includes the first message authentication code, the first random number, and the first parameter set;

receive a second random number, a second message authentication code, and an encrypted communication key that are sent by the network authentication server; and

after the second message authentication code has been authenticated based on the second random number, decrypt the encrypted communication key based on the second-level key to obtain the communication key; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In an eighth feasible authentication manner, the key receiving module 1801 is further configured to receive a first parameter set sent by the user management server; and the authentication module 1802 is specifically configured to:

determine a first random number; encrypt the first random number by using the second-level key, to obtain an encrypted first random number; generate the communication key of the terminal device based on a second parameter set and at least one of the second-level key and the first random number by using a key derivation function; generate a first message authentication code based on either of the second-level key and the communication key and at least one of the second parameter set and the first random number by using a message authentication code generation function; and send an authentication request message to the network authentication server, where the authentication request message includes the first message authentication code, the encrypted first random number, and the first parameter set; and

receive a second message authentication code and an encrypted second random number that are sent by the network authentication server; decrypt the encrypted second random number based on the second-level key to obtain a second random number, where the encrypted second random number is obtained after the network authentication server encrypts the second random number by using the second-level key; and attempt to authenticate the second message authentication code based on the second random number and determine that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a ninth feasible authentication manner, the key receiving module 1801 is further configured to receive a first parameter set sent by the user management server; and the authentication module 1802 is specifically configured to:

determine a first random number; generate the communication key of the terminal device based on the second-level key and at least one of the first random number and a second parameter set by using a key derivation function; generate a first message authentication code based on either of the second-level key and the communication key and at least one of the second parameter set and the first random number by using a message authentication code generation function; and send an authentication request message to the network authentication server, where the authentication request message includes the first message authentication code, the first random number, and the first parameter set; and

receive a second random number and a second message authentication code that are sent by the network authentication server, and attempt to authenticate the second message authentication code and determine that the authentication succeeds; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In a tenth feasible authentication manner, the key receiving module 1801 is further configured to receive a first parameter set sent by the user management server; and the authentication module 1802 is specifically configured to:

determine a first random number and a first transmission parameter of a DH protocol; generate a first message authentication code based on the second-level key, the first random number, and a second parameter set by using a message authentication code generation function; and send an authentication request message to the network authentication server, where the authentication request message includes the first random number, the first transmission parameter, the first message authentication code, and the first parameter set;

receive a second transmission parameter, a second random number, and a second message authentication code that are sent by the network authentication server, and perform a DH key agreement algorithm based on the first transmission parameter and the second transmission parameter to obtain a third transmission parameter; and

after the second message authentication code has been authenticated, generate the communication key of the terminal device based on the third transmission parameter and at least one of the first random number, the second random number, and the second parameter set by using a key derivation function; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key; and

the second parameter set includes at least one of the user identifier of the user management server, the device identifier of the terminal device, the network identifier of the user management server, and the service parameter.

In the authentication manner based on the identity key technology, the second-level key is a private key of the terminal device, and a public key of the terminal device is corresponding to the second-level key. The authentication manner based on the identity key technology includes the following possible implementations.

In an eleventh feasible authentication manner, the key receiving module 1801 is further configured to receive the public key of the terminal device, a first digital signature, and a second parameter set that are sent by the user management server; and the authentication module 1802 is specifically configured to:

determine a first random number, encrypt the first random number by using a public key of the network authentication server, to obtain an encrypted first random number, and send an authentication request message to the network authentication server, where the authentication request message includes the public key of the terminal device, the first digital signature, the encrypted first random number, and the second parameter set;

receive an encrypted second random number and a second digital signature that are sent by the network authentication server, and decrypt the encrypted second random number based on the second-level key of the terminal device to obtain a second random number, where the encrypted second random number is obtained after the network authentication server encrypts the second random number by using the public key of the terminal device; and

after the second digital signature has been authenticated, generate the communication key of the terminal device based on the second parameter set and at least one of the first random number and the second random number by using a key derivation function; generate a first message authentication code based on the communication key, the first random number, the second random number, and the second parameter set, or generate a third digital signature based on the second-level key, the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

In a twelfth feasible authentication manner, the key receiving module 1801 is further configured to receive the public key of the terminal device and a second parameter set that are sent by the user management server; and the authentication module 1802 is specifically configured to:

determine a first random number, encrypt the first random number by using a public key of the network authentication server, to obtain an encrypted first random number, and send an authentication request message to the network authentication server, where the authentication request message includes the public key of the terminal device, the encrypted first random number, and the second parameter set;

receive an encrypted second random number and a second digital signature that are sent by the network authentication server, and decrypt the encrypted second random number based on the second-level key of the terminal device to obtain a second random number, where the encrypted second random number is obtained after the network authentication server encrypts the second random number by using the public key of the terminal device; and

after the second digital signature has been authenticated, generate the communication key of the terminal device based on the second parameter set and at least one of the first random number and the second random number by using a key derivation function; generate a first message authentication code based on the communication key, the first random number, the second random number, and the second parameter set, or generate a third digital signature based on the second-level key, the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

In a thirteenth feasible authentication manner, the key receiving module 1801 is further configured to receive a public key of the user management server and a second parameter set that are sent by the user management server, where the public key of the user management server is a public key of the terminal device that is corresponding to the second-level key of the terminal device; and the authentication module 1802 is specifically configured to:

determine a first random number and a first transmission parameter of a DH protocol, and send an authentication request message to the network authentication server, where the authentication request message includes the public key of the terminal device, the first random number, the first transmission parameter, and the second parameter set;

receive a second transmission parameter, a second random number, and a second digital signature that are sent by the network authentication server, and perform a DH key agreement algorithm based on the first transmission parameter and the second transmission parameter to obtain a third transmission parameter; and

after the second digital signature has been authenticated, generate the communication key of the terminal device based on the third transmission parameter and at least one of the first random number, the second random number, and the second parameter set by using a key derivation function; generate a first message authentication code based on the communication key, the first transmission parameter, the second transmission parameter, and at least one of the first random number, the second random number, and the second parameter set by using a message authentication code generation function, or generate a third digital signature based on the second-level key, the first transmission parameter, the second transmission parameter, and at least one of the first random number, the second random number, and the second parameter set; and send the first message authentication code or the third digital signature to the network authentication server, so that the network authentication server attempts to authenticate the first message authentication code or the third digital signature; where

the second parameter set includes at least one of a user identifier of the user management server, a device identifier of the terminal device, a network identifier of the user management server, and a service parameter.

In the authentication manner based on the identity key technology, the terminal device further includes a public key request module, configured to send a public key request message to the network authentication server; and the key receiving module is further configured to receive the public key of the network authentication server that is sent by the network authentication server.

Optionally, the authentication module 1802 is specifically configured to: perform mutual authentication with the network authentication server, and generate a session key of the terminal device based on any one of the communication key, the second parameter set, a random number of the session key, a fresh parameter of the session key, and a preset time parameter of the session key by using a key derivation function.

Still another aspect of the embodiments of the present invention provides a network authentication server to execute the key authentication method in the foregoing embodiment, so as to implement signaling interaction with the terminal device and complete mutual authentication. This aspect has the same technical features and technical effects as the foregoing method embodiment.

As described in the foregoing method embodiment, a mutual authentication process performed by the network authentication server includes at least an authentication manner based on a symmetric key technology and an authentication manner based on an identity key technology.

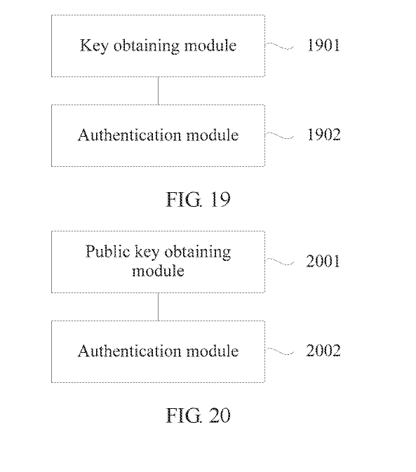

In the authentication manner based on the symmetric key technology, the network authentication server provided in the embodiments of the present invention is described in detail with reference to FIG. 19. FIG. 19 is a schematic structural diagram of Embodiment 1 of the network authentication server according to the present invention. As shown in FIG. 19, the server includes:

a key obtaining module 1901, configured to: receive an authentication request message sent by a terminal device, where the authentication request message includes a first parameter set, send a second key request message to a service center server, and receive a second-level key sent by the service center server, where the second key request message includes the first parameter set; or receive an authentication request message sent by a terminal device, where the authentication request message includes a first parameter set, send a second key request message to a service center server, receive a first-level key sent by the service center server, and generate a second-level key of the terminal device based on the first-level key and the first parameter set by using a key derivation function; and

an authentication module 1902, configured to perform mutual authentication with the terminal device based on the second-level key, to obtain a communication key for communication between the terminal device and a functional network element; where

the first parameter set includes at least one of a user identifier of the user management server, a device identifier of the terminal device, a network identifier of the user management server, a service parameter, a key random number of the second-level key, a fresh parameter of the second-level key, and a time parameter of the second-level key.

In the authentication manner based on the symmetric key technology, an authentication manner of the authentication module 1902 includes the following possible implementations.

In a first feasible authentication manner, the authentication request message further includes an encrypted first random number, and the authentication module 1902 is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key;

generate the communication key of the network authentication server based on a second parameter set and at least one of the second-level key, the first random number, and the second random number by using the key derivation function;

generate a second message authentication code based on the first random number, the second random number, the second parameter set, and either of the communication key and the second-level key; and send the encrypted second random number and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

In a second feasible authentication manner, the authentication request message further includes a first random number, and the authentication module 1902 is specifically configured to:

determine a second random number; generate the communication key of the network authentication server based on the second-level key and at least one of the first random number, the second random number, and a second parameter set by using the key derivation function; generate a second message authentication code based on the first random number, the second random number, the second parameter set, and either of the communication key and the second-level key; and send the second random number and the second message authentication code to the terminal device; and receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

In a third feasible authentication manner, the authentication request message further includes a first random number, and the authentication module 1902 is specifically configured to:

determine a second random number; generate the communication key of the network authentication server based on a key random number; encrypt the communication key by using the second-level key, to obtain an encrypted communication key; generate a second message authentication code based on the first random number, the second random number, a second parameter set, and either of the communication key and the second-level key; and send the second random number, the encrypted communication key, and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

In a fourth feasible authentication manner, the authentication request message further includes a first transmission parameter and a first random number, and the authentication module 1902 is specifically configured to:

determine a second random number and a second transmission parameter of a DH protocol, and perform a DH key agreement algorithm based on the first transmission parameter and the second transmission parameter to obtain a third transmission parameter;

generate the communication key of the network authentication server based on the third transmission parameter and at least one of the first random number, the second random number, and a second parameter set by using the key derivation function; generate a second message authentication code based on the first transmission parameter, the second transmission parameter, the second parameter set, and either of the communication key and the second-level key; and send an encrypted second random number and the second message authentication code to the terminal device; and

receive a first message authentication code sent by the terminal device, and send the communication key to the functional network element after the first message authentication code has been authenticated; where

the second parameter set includes at least one of the user identifier of the user management server, the device identifier of the terminal device, the network identifier of the user management server, and the service parameter.

In a fifth feasible authentication manner, the authentication request message further includes a first message authentication code and an encrypted first random number, and the authentication module 1902 is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key; and

after the first message authentication code has been authenticated, generate the communication key of the network authentication server based on a second parameter set and at least one of the second-level key, the first random number, and the second random number by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

In a sixth feasible authentication manner, the authentication request message further includes a first message authentication code and a first random number, and the authentication module 1902 is specifically configured to:

determine a second random number; after the first message authentication code has been authenticated, generate the communication key of the network authentication server based on the second-level key and at least one of the first random number, the second random number, and a second parameter set by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

In a seventh feasible authentication manner, the authentication request message further includes a first message authentication code and a first random number, and the authentication module 1902 is specifically configured to:

determine a second random number; after the first message authentication code has been authenticated, generate the communication key of the network authentication server based on a key random number; encrypt the communication key by using the second-level key, to obtain an encrypted communication key; generate a second message authentication code based on either of the communication key and the second-level key and at least one of the first random number, the second random number, and a second parameter set; and send the second random number, the encrypted communication key, and the second message authentication code to the terminal device, and send the communication key to the functional network element; where

the second parameter set includes at least one of the user identifier of the user management server, the device identifier of the terminal device, the network identifier of the user management server, and the service parameter.

In an eighth feasible authentication manner, the authentication request message further includes a first message authentication code and an encrypted first random number, and the authentication module 1902 is specifically configured to:

decrypt the encrypted first random number based on the second-level key to obtain a first random number, determine a second random number, and encrypt the second random number by using the second-level key, to obtain an encrypted second random number, where the encrypted first random number is obtained after the terminal device encrypts the first random number by using the second-level key; and

after the first message authentication code has been authenticated, generate the communication key of the terminal device based on a second parameter set and at least one of the second-level key and the first random number by using the key derivation function; generate a second message authentication code based on either of the communication key and the second-level key and at least one of the first random number, the second random number, and the second parameter set; and send the encrypted second random number and the second message authentication code to the terminal device, and send the communication key to the functional network element; where

the second parameter set includes at least one of the user identifier of the user management server, the device identifier of the terminal device, the network identifier of the user management server, and the service parameter.

In a ninth feasible authentication manner, the authentication request message further includes a first message authentication code and a first random number, and the authentication module 1902 is specifically configured to:

determine a second random number; after the first message authentication code has been authenticated, generate the communication key of the terminal device based on the second-level key and at least one of the first random number and a second parameter set by using the key derivation function; generate a second message authentication code based on either of the communication key and the second-level key and at least one of the first random number, the second random number, and the second parameter set; and send the second random number and the second message authentication code to the terminal device, and send the communication key to the functional network element; where

the second parameter set includes at least one of the user identifier of the user management server, the device identifier of the terminal device, the network identifier of the user management server, and the service parameter.

In a tenth feasible authentication manner, the authentication request message further includes a first message authentication code, a first transmission parameter, and a first random number, and the authentication module 1902 is specifically configured to:

determine a second random number and a second transmission parameter of a DH protocol, and perform a DH key agreement algorithm based on the first transmission parameter and the second transmission parameter to obtain a third transmission parameter; and

after the first message authentication code has been authenticated, generate the communication key of the network authentication server based on the third transmission parameter and at least one of the first random number, the second random number, and a second parameter set by using the key derivation function; generate a second message authentication code based on either of the communication key and the second-level key and any one of the first random number, the second random number, the first transmission parameter, the second transmission parameter, and the second parameter set; and send the second random number and the second message authentication code to the terminal device, and send the communication key to the functional network element; where

the second parameter set includes at least one of the user identifier of the user management server, the device identifier of the terminal device, the network identifier of the user management server, and the service parameter.

In the authentication manner based on the asymmetric key technology, the network authentication server provided in the embodiments of the present invention is described in detail with reference to FIG. 20. FIG. 20 is a schematic structural diagram of Embodiment 2 of the network authentication server according to the present invention. As shown in FIG. 20, the network authentication server includes:

a public key obtaining module 2001, configured to receive an authentication request message sent by a terminal device, where the authentication request message includes a public key of the terminal device; and

an authentication module 2002, configured to perform mutual authentication with the terminal device based on the public key of the terminal device, a public key of the network authentication server, and a private key of the network authentication server, to obtain a communication key for communication between the terminal device and a functional network element.

In the authentication manner based on the asymmetric key technology, an authentication manner of the authentication module 2002 includes the following possible implementations.

In an eleventh feasible authentication manner, the authentication request message further includes a first digital signature, an encrypted first random number, and a second parameter set, and the authentication module 2002 is specifically configured to:

decrypt the encrypted first random number based on the private key of the network authentication server to obtain a first random number, determine a second random number, and encrypt the second random number by using the public key of the terminal device, to obtain an encrypted second random number, where the encrypted first random number is obtained after the terminal device encrypts the first random number by using the public key of the network authentication server;

after the first digital signature has been authenticated, generate the communication key of the network authentication server based on the second parameter set and at least one of the first random number and the second random number by using a key derivation function; generate a second digital signature based on the private key of the network authentication server, the first random number, the second random number, and the second parameter set; and send the second digital signature and the encrypted second random number to the terminal device; and

receive a first message authentication code or a third digital signature sent by the terminal device, and send the communication key to the functional network element after the first message authentication code or the third digital signature has been authenticated, where

the second parameter set includes at least one of a user identifier of the user management server, a device identifier of the terminal device, a network identifier of the user management server, and a service parameter.

In a twelfth feasible authentication manner, the authentication request message further includes an encrypted first random number and a second parameter set, and the authentication module 2002 is specifically configured to:

decrypt the encrypted first random number based on the private key of the network authentication server to obtain a first random number, determine a second random number, and encrypt the second random number by using the public key of the terminal device, to obtain an encrypted second random number, where the encrypted first random number is obtained after the terminal device encrypts the first random number by using the public key of the network authentication server; generate the communication key of the network authentication server based on the second parameter set and at least one of the first random number and the second random number by using a key derivation function; generate a second digital signature based on the private key of the network authentication server, the first random number, the second random number, and the second parameter set; and send the encrypted second random number and the second digital signature to the terminal device; and

receive a first message authentication code or a third digital signature sent by the terminal device, and send the communication key to the functional network element after the first message authentication code or the third digital signature has been authenticated; where

the second parameter set includes at least one of a user identifier of the user management server, a device identifier of the terminal device, a network identifier of the user management server, and a service parameter.

In a thirteenth feasible authentication manner, the authentication request message further includes a first random number, a first transmission parameter, and a second parameter set; a public key of the user management server is the public key of the terminal device that is corresponding to a second-level key of the terminal device; and the authentication module 2002 is specifically configured to:

determine a second random number and a second transmission parameter of a DH protocol, and perform a DH key agreement algorithm based on the first transmission parameter and the second transmission parameter to obtain a third transmission parameter;

generate the communication key of the network authentication server based on the third transmission parameter and at least one of the first random number, the second random number, and the second parameter set by using a key derivation function; generate a second digital signature based on the private key of the network authentication server, the first transmission parameter, the second transmission parameter, and at least one of the first random number, the second random number, and the second parameter set; and send the second random number, the second transmission parameter, and the second digital signature to the terminal device; and

receive a first message authentication code or a third digital signature sent by the terminal device, and send the communication key to the functional network element after the first message authentication code has been authenticated or after the third digital signature has been authenticated based on the public key of the terminal device; where

the second parameter set includes at least one of a user identifier of the user management server, a device identifier of the terminal device, a network identifier of the user management server, and a service parameter.

In any one of the foregoing authentication manners based on the identity key technology, the server further includes: a public key request receiving module, configured to receive a public key request message sent by the terminal device; and a public key sending module, configured to send the public key of the network authentication server to the terminal device.

Optionally, in the authentication manners based on the symmetric key technology and based on the identity key technology, the authentication module 1902 or the authentication module 2002 may further be specifically configured to: perform mutual authentication with the terminal device, generate a session key of the network authentication server based on any one of the communication key, the second parameter set, a random number of the session key, a fresh parameter of the session key, and a preset time parameter of the session key by using a key derivation function, and send the session key to the functional network element.

Optionally, the terminal device shown in FIG. 18 and the network authentication server shown in FIG. 20 may be further configured to execute the sixth to the thirteenth possible authentication implementations shown in FIG. 8 to FIG. 15.

Still another aspect of the embodiments of the present invention provides a storage medium. The storage medium is a computer-readable storage medium storing one or more programs. The one or more programs include instructions. When the instruction is executed by an electronic device including a plurality of application programs, the electronic device executes any one of the foregoing methods in the embodiments of the key distribution method executed by the service center server.

Still another aspect of the embodiments of the present invention provides a storage medium. The storage medium is a computer-readable storage medium storing one or more programs. The one or more programs include instructions. When the instruction is executed by an electronic device including a plurality of application programs, the electronic device executes any one of the foregoing methods in the embodiments of the key distribution method executed by the user management server.

Still another aspect of the embodiments of the present invention provides a storage medium. The storage medium is a computer-readable storage medium storing one or more programs. The one or more programs include instructions. When the instruction is executed by an electronic device including a plurality of application programs, the electronic device executes any one of the foregoing methods in the embodiments of the key authentication method executed by the terminal device.

Still another aspect of the embodiments of the present invention provides a storage medium. The storage medium is a computer-readable storage medium storing one or more programs. The one or more programs include instructions. When the instruction is executed by an electronic device including a plurality of application programs, the electronic device executes any one of the foregoing methods in the embodiments of the key distribution method executed by the network authentication server.

Still another aspect of the embodiments of the present invention provides a key distribution and authentication system to execute the key distribution and authentication method in the foregoing embodiment. The key distribution and authentication system has the same technical features and technical effects as the key distribution and authentication method in the foregoing embodiment.

The system includes the service center server in any one of the foregoing embodiments, the user management server in any one of the foregoing embodiments, the terminal device in any one of the foregoing embodiments, and the network authentication server in any one of the foregoing embodiments.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

In the specification, claims, and accompanying drawings of the present invention, the terms “first”, “second”, “third”, “fourth”, and so on (if existent) are intended to distinguish between similar objects but do not necessarily indicate a specific order or sequence. It should be understood that the data termed in such a way are interchangeable in proper circumstances so that the embodiments of the present invention described herein can be implemented in orders except the order illustrated or described herein. Moreover, the terms “include”, “contain” and any other variants mean to cover the non-exclusive inclusion, for example, a process, method, system, product, or device that includes a list of steps or units is not necessarily limited to those units, but may include other units not expressly listed or inherent to such a process, method, system, product, or device.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A key distribution method, comprising:
receiving, by a terminal device, a second-level key of the terminal device from a user management server; and
performing, by the terminal device, mutual authentication with a network authentication server based on the second-level key, to obtain a communication key for communication between the terminal device and a functional network element.

2. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number, encrypting the first random number using the second-level key, to obtain an encrypted first random number, and sending an authentication request message to the network authentication server, wherein the authentication request message comprises the first parameter set and the encrypted first random number;
receiving, by the terminal device, an encrypted second random number and a second message authentication code from the network authentication server, and decrypting the encrypted second random number based on the second-level key to obtain a second random number, wherein the encrypted second random number is obtained after the network authentication server encrypts the second random number using the second-level key; and
after the terminal device has authenticated the second message authentication code, generating, by the terminal device, the communication key of the terminal device based on a second parameter set and at least one of the second-level key, the first random number, and the second random number using a key derivation function; generating a first message authentication code based on the first random number, the second random number, the second parameter set, and either of the communication key and the second-level key; and sending the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

3. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number, and sending an authentication request message to the network authentication server, wherein the authentication request message comprises the first parameter set and the first random number;
receiving, by the terminal device, a second random number and a second message authentication code from the network authentication server; and
after the terminal device has authenticated the second message authentication code, generating, by the terminal device, the communication key of the terminal device based on the second-level key and at least one of the first random number, the second random number, and a second parameter set using a key derivation function; generating a first message authentication code based on the first random number, the second random number, the second parameter set, and either of the communication key and the second-level key; and sending the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

4. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number, and sending an authentication request message to the network authentication server, wherein the authentication request message comprises the first parameter set and the first random number;
receiving, by the terminal device, a second random number, a second message authentication code, and an encrypted communication key from the network authentication server, and decrypting the encrypted communication key based on the second-level key to obtain the communication key, wherein the encrypted communication key is obtained after the network authentication server encrypts the communication key using the second-level key; and
after the terminal device has authenticated the second message authentication code, generating, by the terminal device, a first message authentication code based on the first random number, the second random number, the second parameter set, and either of the communication key and the second-level key; and sending the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

5. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number and a first transmission parameter of a DH protocol, and sending an authentication request message to the network authentication server, wherein the authentication request message comprises the first random number, the first transmission parameter, and the first parameter set;
receiving, by the terminal device, a second transmission parameter, a second random number, and a second message authentication code from the network authentication server, and performing a DH key agreement algorithm based on the first transmission parameter and the second transmission parameter to obtain a third transmission parameter; and
after the terminal device has authenticated the second message authentication code, generating, by the terminal device, the communication key of the terminal device based on the third transmission parameter and at least one of the first random number, the second random number, and a second parameter set using a key derivation function; generating a first message authentication code based on the first random number, the second random number, the second parameter set, and either of the communication key and the second-level key using a message authentication code generation function; and sending the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

6. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number; encrypting the first random number using the second-level key, to obtain an encrypted first random number; generating a first message authentication code based on the second-level key and at least one of a second parameter set and the first random number using a message authentication code generation function; and sending an authentication request message to the network authentication server, wherein the authentication request message comprises the first message authentication code, the encrypted first random number, and the first parameter set;
receiving, by the terminal device, a second message authentication code and an encrypted second random number from the network authentication server, and decrypting the encrypted second random number based on the second-level key to obtain a second random number, wherein the encrypted second random number is obtained after the network authentication server encrypts the second random number using the second-level key; and
after the terminal device has authenticated the second message authentication code, generating, by the terminal device, the communication key of the terminal device based on the second parameter set and at least one of the second-level key, the first random number, and the second random number using a key derivation function; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

7. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number; generating a first message authentication code based on the second-level key and at least one of a second parameter set and the first random number using a message authentication code generation function; and sending an authentication request message to the network authentication server, wherein the authentication request message comprises the first message authentication code, the first random number, and the first parameter set;
receiving, by the terminal device, a second random number and a second message authentication code from the network authentication server; and
after the terminal device has authenticated the second message authentication code, generating, by the terminal device, the communication key of the terminal device based on the second-level key and at least one of the first random number, the second random number, and the second parameter set using a key derivation function; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

8. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number; generating a first message authentication code based on the second-level key and at least one of a second parameter set and the first random number using a message authentication code generation function; and sending an authentication request message to the network authentication server, wherein the authentication request message comprises the first message authentication code, the first random number, and the first parameter set;
receiving, by the terminal device, a second random number, a second message authentication code, and an encrypted communication key from the network authentication server; and
after the terminal device has authenticated the second message authentication code based on the second random number, decrypting, by the terminal device, the encrypted communication key based on the second-level key to obtain the communication key; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

9. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number; encrypting the first random number using the second-level key, to obtain an encrypted first random number; generating the communication key of the terminal device based on a second parameter set and at least one of the second-level key and the first random number using a key derivation function; generating a first message authentication code based on either of the second-level key and the communication key and at least one of the second parameter set and the first random number using a message authentication code generation function; and sending an authentication request message to the network authentication server, wherein the authentication request message comprises the first message authentication code, the encrypted first random number, and the first parameter set; and
receiving, by the terminal device, a second message authentication code and an encrypted second random number from the network authentication server; decrypting the encrypted second random number based on the second-level key to obtain a second random number, wherein the encrypted second random number is obtained after the network authentication server encrypts the second random number using the second-level key; and attempting to authenticate the second message authentication code based on the second random number and determining that the authentication succeeds; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

10. The method according to claim 1, wherein the method further comprises:
receiving, by the terminal device, a first parameter set from the user management server; and
the performing, by the terminal device, mutual authentication with a network authentication server based on the second-level key, to obtain a communication key for communication between the terminal device and a functional network element comprises:
determining, by the terminal device, a first random number; generating the communication key of the terminal device based on the second-level key and at least one of the first random number and a second parameter set using a key derivation function; generating a first message authentication code based on either of the second-level key and the communication key and at least one of the second parameter set and the first random number using a message authentication code generation function; and sending an authentication request message to the network authentication server, wherein the authentication request message comprises the first message authentication code, the first random number, and the first parameter set; and
receiving, by the terminal device, a second random number and a second message authentication code from the network authentication server, and attempting to authenticate the second message authentication code and determining that the authentication succeeds; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

11. A terminal device, comprising:
a receiver, the receiver configured to receive a second-level key of the terminal device from a user management server; and
at least one processor, the at least one processor configured to perform mutual authentication with a network authentication server based on the second-level key, to obtain a communication key for communication between the terminal device and a functional network element.

12. The terminal device according to claim 11, wherein the receiver is further configured to receive a first parameter set from the user management server; and
the at least one processor is configured to:
determine a first random number, encrypt the first random number using the second-level key, to obtain an encrypted first random number, and send an authentication request message to the network authentication server, wherein the authentication request message comprises the first parameter set and the encrypted first random number;
receive an encrypted second random number and a second message authentication code from the network authentication server, and decrypt the encrypted second random number based on the second-level key to obtain a second random number, wherein the encrypted second random number is obtained after the network authentication server encrypts the second random number using the second-level key, and
after the second message authentication code has been authenticated, generate the communication key of the terminal device based on a second parameter set and at least one of the second-level key, the first random number, and the second random number using a key derivation function; generate a first message authentication code based on the first random number, the second random number, the second parameter set, and either of the communication key and the second-level key;, and send the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

13. The terminal device according to claim 11, wherein the receiver is further configured to receive a first parameter set from the user management server; and
the at least one processor is configured to:
determine a first random number, and send an authentication request message to the network authentication server, wherein the authentication request message comprises the first parameter set and the first random number;
receive a second random number and a second message authentication code from the network authentication server; and
after the second message authentication code has been authenticated, generate the communication key of the terminal device based on the second-level key and at least one of the first random number, the second random number, and a second parameter set using a key derivation function; generate a first message authentication code based on the first random number, the second random number, the second parameter set, and either of the communication key and the second-level key; and send the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

14. The terminal device according to claim 11, wherein the receiver is further configured to receive a first parameter set from the user management server; and
the at least one processor is configured to:
determine a first random number, and send an authentication request message to the network authentication server, wherein the authentication request message comprises the first parameter set and the first random number;
receive a second random number, a second message authentication code, and an encrypted communication key from the network authentication server, and decrypt the encrypted communication key based on the second-level key to obtain the communication key, wherein the encrypted communication key is obtained after the network authentication server encrypts the communication key using the second-level key; and
after the second message authentication code has been authenticated, generate a first message authentication code based on the first random number, the second random number, the second parameter set, and either of the communication key and the second-level key; and send the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

15. The terminal device according to claim 11, wherein the receiver is further configured to receive a first parameter set from the user management server; and
the at least one processor is configured to:
determine a first random number and a first transmission parameter of a DH protocol, and send an authentication request message to the network authentication server, wherein the authentication request message comprises the first random number, the first transmission parameter, and the first parameter set;
receive a second transmission parameter, a second random number, and a second message authentication code from the network authentication server, and perform a DH key agreement algorithm based on the first transmission parameter and the second transmission parameter to obtain a third transmission parameter; and
after the second message authentication code has been authenticated, generate the communication key of the terminal device based on the third transmission parameter and at least one of the first random number, the second random number, and a second parameter set using a key derivation function; generate a first message authentication code based on the first random number, the second random number, the second parameter set, and either of the communication key and the second-level key using a message authentication code generation function; and send the first message authentication code to the network authentication server, wherein the network authentication server attempts to authenticate the first message authentication code; and wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

16. The terminal device according to claim 11, wherein the receiver is further configured to receive a first parameter set from the user management server; and
the at least one processor is configured to:
determine a first random number; encrypt the first random number using the second-level key, to obtain an encrypted first random number; generate a first message authentication code based on the second-level key and at least one of a second parameter set and the first random number using a message authentication code generation function; and send an authentication request message to the network authentication server, wherein the authentication request message comprises the first message authentication code, the encrypted first random number, and the first parameter set;
receive a second message authentication code and an encrypted second random number from the network authentication server, and decrypt the encrypted second random number based on the second-level key to obtain a second random number, wherein the encrypted second random number is obtained after the network authentication server encrypts the second random number using the second-level key; and
after the second message authentication code has been authenticated, generate the communication key of the terminal device based on the second parameter set and at least one of the second-level key, the first random number, and the second random number using a key derivation function; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

17. The terminal device according to claim 11, wherein the receiver is further configured to receive a first parameter set from the user management server; and
the at least one processor is configured to:
determine a first random number; generate a first message authentication code based on the second-level key and at least one of a second parameter set and the first random number using a message authentication code generation function; and send an authentication request message to the network authentication server, wherein the authentication request message comprises the first message authentication code, the first random number, and the first parameter set;
receive a second random number and a second message authentication code from the network authentication server; and
after the second message authentication code has been authenticated, generate the communication key of the terminal device based on the second-level key and at least one of the first random number, the second random number, and the second parameter set using a key derivation function; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

18. The terminal device according to claim 11, wherein the receiver is further configured to receive a first parameter set from the user management server; and
the at least one processor is configured to:
determine a first random number; generate a first message authentication code based on the second-level key and at least one of a second parameter set and the first random number using a message authentication code generation function; and
send an authentication request message to the network authentication server, wherein the authentication request message comprises the first message authentication code, the first random number, and the first parameter set;
receive a second random number, a second message authentication code, and an encrypted communication key from the network authentication server; and
after the second message authentication code has been authenticated based on the second random number, decrypt the encrypted communication key based on the second-level key to obtain the communication key; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

19. The terminal device according to claim 11, wherein the receiver is further configured to receive a first parameter set from the user management server; and
the at least one processor is configured to:
determine a first random number; encrypt the first random number using the second-level key, to obtain an encrypted first random number; generate the communication key of the terminal device based on a second parameter set and at least one of the second-level key and the first random number using a key derivation function; generate a first message authentication code based on either of the second-level key and the communication key and at least one of the second parameter set and the first random number using a message authentication code generation function; and send an authentication request message to the network authentication server, wherein the authentication request message comprises the first message authentication code, the encrypted first random number, and the first parameter set; and
receive a second message authentication code and an encrypted second random number from the network authentication server; decrypt the encrypted second random number based on the second-level key to obtain a second random number, wherein the encrypted second random number is obtained after the network authentication server encrypts the second random number using the second-level key; and attempt to authenticate the second message authentication code based on the second random number and determine that the authentication succeeds; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.

20. The terminal device according to claim 11, wherein the receiver is further configured to receive a first parameter set from the user management server; and
the at least one processor is configured to:
determine a first random number; generate the communication key of the terminal device based on the second-level key and at least one of the first random number and a second parameter set using a key derivation function; generate a first message authentication code based on either of the second-level key and the communication key and at least one of the second parameter set and the first random number using a message authentication code generation function; and send an authentication request message to the network authentication server, wherein the authentication request message comprises the first message authentication code, the first random number, and the first parameter set; and
receive a second random number and a second message authentication code from the network authentication server, and attempt to authenticate the second message authentication code and determine that the authentication succeeds; wherein:
the first parameter set comprises at least one of a user identifier of the user management server, a device identifier of the terminal device, a network identifier of the user management server, a service parameter, a key random number of the second-level key, a fresh parameter of the second-level key, and a time parameter of the second-level key; and
the second parameter set comprises at least one of the user identifier of the user management server, the device identifier of the terminal device, the network identifier of the user management server, and the service parameter.
